(19) United States
(12) Patent Application Publication
(10) Pub. No.: US 2024/0385360 A1
(43) Pub. Date: Nov. 21, 2024

(54) OPTICAL FILM, OPTICALLY ANISOTROPIC LAYER, COMPOSITION FOR FORMING ALIGNMENT FILM, METHOD FOR PRODUCING OPTICAL FILM, POLARIZING PLATE, AND IMAGE DISPLAY DEVICE

(71) Applicant: FUJIFILM Corporation, Tokyo (JP)

(72) Inventors: Yuta FUKUSHIMA, Kanagawa (JP); Shinpei YOSHIDA, Kanagawa (JP); Tomonori MIMURA, Kanagawa (JP); Shun KITAWAKI, Kanagawa (JP); Yuta TAKAHASHI, Kanagawa (JP)

(73) Assignee: FUJIFILM Corporation, Tokyo (JP)

(21) Appl. No.: 18/789,111

(22) Filed: Jul. 30, 2024

Related U.S. Application Data
(63) Continuation of application No. PCT/JP2023/007741, filed on Mar. 2, 2023.

(30) Foreign Application Priority Data
Mar. 9, 2022 (JP) 2022-036023
Dec. 19, 2022 (JP) 2022-202103

(51) Int. Cl. G02B 5/30

(52) U.S. Cl. CPC G02B 5/3083; G02B 5/3016

(57) ABSTRACT

An optical film having good alignment properties of a liquid crystal compound in an optically anisotropic layer while suppressing an occurrence of bright point defects, an optically anisotropic layer, a composition for forming an alignment film, a method for producing an optical film, a polarizing plate, and an image display device. The optical film includes an alignment film and an optically anisotropic layer, in which the optically anisotropic layer is a layer formed of a composition for forming an optically anisotropic layer, containing a polymerizable liquid crystal compound, and the alignment film is a film formed of a composition for forming an alignment film, containing an additive having an alkyl group having 5 to 29 carbon atoms and a polymer having no alkyl group having 5 to 29 carbon atoms.

### CROSS-REFERENCE TO RELATED APPLICATIONS

This application is a Continuation of PCT International Application No. PCT/JP2023/007741 filed on Mar. 2, 2023, which was published under PCT Article 21(2) in Japanese, and which claims priority under 35 U.S.C. § 119(a) to Japanese Patent Application No. 2022-036023, filed on Mar. 9, 2022, and Japanese Patent Application No. 2022-202103, filed on Dec. 19, 2022. All the above applications are hereby expressly incorporated by reference, in their entirety, into the present application.

### BACKGROUND OF THE INVENTION

### 1. Field of the Invention

The present invention relates to an optical film, an optically anisotropic layer, a composition for forming an alignment film, a method for producing an optical film, a polarizing plate, and an image display device.

### 2. Description of the Related Art

Optical films such as an optical compensation sheet and a phase difference film are used in various image display devices in order to eliminate image coloration or expand a view angle.

A stretched birefringent film has been used as the optical film, but in recent years, it has been proposed to use an optical film having an optically anisotropic layer consisting of a liquid crystal compound instead of the stretched birefringent film.

In a case of forming such an optically anisotropic layer, an alignment film is typically used.

For example, JP1997-152509A (JP-H09-152509A) describes an aspect in which an optically anisotropic layer is formed on an alignment film formed of a coating liquid including a polyvinyl alcohol having a specific group ([Claim 1], [Claim 2], and [Examples]).

### SUMMARY OF THE INVENTION

Meanwhile, it is known that an alignment film is generally used after being imparted with an alignment restricting force through a rubbing treatment, but due to scraps of the alignment film generated in the process of the rubbing treatment, bright point defects may occur in an optical film having an optically anisotropic layer.

Therefore, the present inventors have conducted studies on the alignment film described in JP1997-152509A (JP-H09-152509A), and as a result, they have found that the alignment properties of a liquid crystal compound in an optically anisotropic layer were good, but there was room for improvement in suppression of bright point defects in consideration of a standard of bright point defects due to improvement of display performance of various devices in recent years and diversification of applications of display devices.

Therefore, an object of the present invention is to provide an optical film in which alignment properties of a liquid crystal compound in an optically anisotropic layer are good and an occurrence of bright point defects is suppressed.

In addition, another object of the present invention is to provide an optically anisotropic layer, a composition for forming an alignment film, a method for producing an optical film, a polarizing plate, and an image display device.

The present inventors have conducted intensive studies to accomplish the objects, and as a result, they have found that by using an alignment film formed of a composition for forming an alignment film, containing an additive having an alkyl group having 5 to 29 carbon atoms and a polymer having no alkyl group having 5 to 29 carbon atoms, the aligning properties of a liquid crystal compound in an optically anisotropic layer are improved and the occurrence of bright point defects in an optical film can be suppressed, thereby completing the present invention.

That is, the present inventors have found that the objects can be accomplished by the following configurations.
[1] An optical film comprising:
an alignment film; and
an optically anisotropic layer,
in which the optically anisotropic layer is a layer formed of a composition for forming an optically anisotropic layer, containing a polymerizable liquid crystal compound, and
the alignment film is a film formed of a composition for forming an alignment film, containing an additive having an alkyl group having 5 to 29 carbon atoms and a polymer having no alkyl group having 5 to 29 carbon atoms.
[2] The optical film according to [1],
in which the additive has a hydrophilic group.
[3] The optical film according to [1] or [2],
in which the additive has an alkyl group having 12 to 22 carbon atoms.
[4] The optical film according to any one of [1] to [3],
in which the polymer is a polyvinyl alcohol or a modified polyvinyl alcohol.
[5] An optically anisotropic layer formed of a composition for forming an optically anisotropic layer, containing a polymerizable liquid crystal compound,
in which bright point defects having a size of 100 μm or more are present at 1 to 80 pieces/10 m² in the optically anisotropic layer, and
a core of the bright point defect contains an additive having an alkyl group having 5 to 29 carbon atoms and a polymer having no alkyl group having 5 to 29 carbon atoms.
[6] The optically anisotropic layer according to [5],
in which the additive has a hydrophilic group.
[7] The optically anisotropic layer according to [5] or [6],
in which the additive has an alkyl group having 12 to 22 carbon atoms.
[8] The optically anisotropic layer according to any one of [5] to [7],
in which the polymer is a polyvinyl alcohol or a modified polyvinyl alcohol.
[9] A composition for forming an alignment film, comprising:
an additive having an alkyl group having 5 to 29 carbon atoms; and
a polymer having no alkyl group having 5 to 29 carbon atoms.
[10] The composition for forming an alignment film according to [9],
in which the additive has a hydrophilic group.
[11] The composition for forming an alignment film according to [9] or [10],
in which the additive has an alkyl group having 12 to 22 carbon atoms.
[12] The composition for forming an alignment film according to any one of [9] to [11],
in which the polymer is a polyvinyl alcohol or a modified polyvinyl alcohol.
[13] A method for producing an optical film, comprising:
an alignment film forming step of forming an alignment film on a support, using the composition for forming an alignment film according to any one of [9] to [12];
a rubbing step of subjecting the alignment film to a rubbing treatment; and
an optically anisotropic layer forming step of forming an optically anisotropic layer on the rubbing-treated alignment film, using a composition for forming an optically anisotropic layer, containing a polymerizable liquid crystal compound.
[14] A polarizing plate comprising:
the optical film according to any one of [1] to [4] or the optically anisotropic layer according to any one of [5] to [8]; and
a polarizer.
[15] An image display device comprising:
the optical film according to any one of [1] to [4] or the optically anisotropic layer according to any one of [5] to [8].
[16] The image display device according to [15],
in which the image display device is a liquid crystal display device.
[17] The image display device according to [15],
in which the image display device is an organic EL display device.

According to the present invention, it is possible to provide an optical film in which alignment properties of a liquid crystal compound in an optically anisotropic layer are good and the occurrence of bright point defects is suppressed.

In addition, according to the present invention, it is possible to provide an optically anisotropic layer, a composition for forming an alignment film, a method for producing an optical film, a polarizing plate, and an image display device.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

Furthermore, in the present specification, a numerical range expressed using “to” means a range that includes the preceding and succeeding numerical values of “to” as the lower limit value and the upper limit value, respectively.

In addition, in the present specification, for each component, one kind of substance corresponding to each component may be used alone, or two or more kinds thereof may be used in combination. Here, in a case where the two or more kinds of the substances are used in combination for each component, the content of the component refers to a total content of the substances used in combination unless otherwise specified.

In addition, in the present specification, “(meth)acrylate” denotes “acrylate” or “methacrylate”, “(meth)acryl” denotes “acryl” or “methacryl”, and “(meth)acryloyl” denotes “acryloyl” or “methacryloyl”.

In addition, in the present specification, a bonding direction of the denoted divalent group (for example, —CO—O—) is not particularly limited unless the bonding position is specified, and for example, in a case where L in X-L-Y is —COO—, L may be either *1-O—CO-*2 or *1-CO—O-*2, in which *1 represents a bonding position to the X side and *2 represents a bonding position to the Y side.

### Optical Film

The optical film of an embodiment of the present invention includes an alignment film and an optically anisotropic layer.

Furthermore, the optically anisotropic layer included in the optical film of the embodiment of the present invention is a layer formed of a composition for forming an optically anisotropic layer, containing a polymerizable liquid crystal compound.

In addition, the alignment film included in the optical film of the embodiment of the present invention is a film formed of a composition for forming an alignment film, containing an additive having an alkyl group having 5 to 29 carbon atoms and a polymer having no alkyl group having 5 to 29 carbon atoms.

In the present invention, by using the alignment film formed of the composition for forming an alignment film, containing the additive having an alkyl group having 5 to 29 carbon atoms (hereinafter also simply referred to as a “specific additive”) and the polymer having no alkyl group having 5 to 29 carbon atoms (hereinafter also simply referred to as a “specific polymer”) as described above, the aligning properties of a liquid crystal compound in an optically anisotropic layer are improved and the occurrence of bright point defects in the optical film can be suppressed.

A reason why such an effect is expressed is not specifically clear, but is presumed to be as follows by the present inventors.

That is, it is considered that by using the specific additive as a component of the composition for forming an alignment film, the friction between a pile of rubbing cloth used in a case of subjecting the alignment film to a rubbing treatment and the alignment film can be reduced, and the amount of dust generated from the alignment film can be reduced, whereby the occurrence of bright point defects can be suppressed. This can be presumed from the actually measured values of a dynamic friction coefficient of the alignment film shown in Table 1 of Examples which will be described later.

In addition, it is considered that by setting the specific additive to have an alkyl group having 5 to 29 carbon atoms, the compatibility with the specific polymer was good and the aggregation of the specific additives was suppressed, and as a result, the specific polymer was appropriately exposed on a surface of the alignment film, whereby the aligning properties of the liquid crystal compound in the optically anisotropic layer formed on the alignment film were improved.

Hereinafter, the alignment film and the optically anisotropic layer, included in the optical film of the embodiment of the present invention, will be described in detail.

### Alignment Film

The alignment film included in the optical film of the embodiment of the present invention is a film formed of the composition for forming an alignment film, containing an additive having an alkyl group having 5 to 29 carbon atoms (specific additive) and a polymer having no alkyl group having 5 to 29 carbon atoms (specific polymer).

### Specific Additive

The specific additive included in the composition for forming an alignment film is an additive having an alkyl group having 5 to 29 carbon atoms.

Here, examples of the alkyl group include a pentyl group, a hexyl group, a heptyl group, an octyl group, a 2-ethylhexyl group, a nonyl group, a decyl group, an undecyl group, a dodecyl group, a tridecyl group, a tetradecyl group, a hexadecyl group (cetyl group), an octadecyl group, an icosyl group, a docosyl group, a tetracosyl group, a hexacosyl group, and a nonacosyl group.

In addition, the alkyl group may be a linear alkyl group or a branched alkyl group, but is preferably the linear alkyl group.

In the present invention, the number of carbon atoms in the alkyl group is preferably 10 to 25, and more preferably 12 to 22 for a reason that the aligning properties of the liquid crystal compound in the optically anisotropic layer are further improved.

For a reason that the alignment properties of the liquid crystal compound in the optically anisotropic layer are further improved, it is preferable that the specific additive has a hydrophilic group, in addition to the alkyl group.

The hydrophilic group is not particularly limited, and any of ionic hydrophilic groups (an anionic hydrophilic group, a cationic hydrophilic group, and an amphoteric hydrophilic group), and nonionic hydrophilic groups can be used.

Examples of the anionic hydrophilic group include a hydroxy group, a carboxy group, carboxylate, a sulfonic acid group, sulfonate, a sulfuric acid ester salt, a phosphoric acid group, and a phosphoric acid ester salt.

Examples of the cationic hydrophilic group include an amino group and a quaternary ammonium salt.

The nonionic hydrophilic group may be any of an ester type, an ether type, an ester/ether type, and an alkanolamide type, and is preferably of the ether type, and more preferably a polyoxyalkylene group (for example, a polyoxyethylene group, a polyoxypropylene group, and a polyoxyalkylene group in which an oxyethylene group and an oxypropylene group are block-bonded or randomly bonded).

Among such hydrophilic groups, the ionic hydrophilic group (provided that the group is limited to a neutralization product such as a carboxylate) or the nonionic hydrophilic group is preferable for a reason that the occurrence of bright point defects in the optical film can be further suppressed.

In the present invention, the specific additive may be a low-molecular-weight compound or a high-molecular-weight compound.

Here, the “low-molecular-weight compound” refers to a specific additive having a molecular weight of 100 or more and less than 2,000.

In addition, the “high-molecular-weight compound” refers to a specific additive having a molecular weight of 2,000 or more, and the weight-average molecular weight (Mw) thereof is preferably 10,000 to 40,000, more preferably 11,000 to 39,000, and still more preferably 13,000 to 35,000. In a case where the weight-average molecular weight is 10,000 or more, unevenness is suppressed during the formation of the liquid crystal cured layer, and in a case where the weight-average molecular weight is 40,000 or less, the alignment properties of the liquid crystal cured layer are further improved.

In addition, in the present invention, the specific additive is preferably a high-molecular-weight compound from the viewpoint that the alignment can be maintained even with a lower friction coefficient, that is, the bright point defects can be suppressed. A clear mechanism by which the effect can be attained by the high-molecular-weight compound is not clear, but it is presumed to be that the high-molecular-weight compound is less likely to aggregate than the low-molecular-weight compound and the alignment film surface can be uniformly coated therewith since the high-molecular-weight compound forms an entanglement while being compatible with the specific polymer which will be described later. Further, it is also preferable that the high-molecular-weight compound has a smaller change in a robust, that is, a dynamic friction coefficient with respect to a drying temperature in a process of forming the alignment film, as compared with the low-molecular-weight compound. This is presumed to be because with the high-molecular-weight compound having good compatibility with the specific polymer which will be described later, the change in compatibility with the specific polymer depending on a drying temperature is small, and thus, the change in the surface coating amount depending on the drying temperature is small.

Specific examples of the above-described low-molecular-weight compound having an alkyl group and an optional hydrophilic group include sodium dodecyl sulfate, polyoxyethylene (10) cetyl ether, polyoxyethylene (20) docosyl ether, tetrahexylammonium bromide, tetra-n-octylammonium bromide, trimethylstearylammonium bromide, and melissic acid.

Examples of the above-described high-molecular-weight compound having an alkyl group and an optional hydrophilic group include a polymer having the above-described alkyl group and hydrophilic group in a side chain of a (meth)acrylic polymer.

As such a polymer, a copolymer having a side chain having the above-described alkyl group (hereinafter also simply referred to as a “hydrophobic part”) and a side chain having the above-described hydrophilic group (hereinafter also simply referred to as a “hydrophilic part”) in separate repeating units is preferable.

Here, the hydrophobic part is not particularly limited as long as it has the above-described alkyl group, but it is preferable that the hydrophobic part has a polyoxyalkylene group as a linking group on the main chain side and has an alkyl group having 12 to 22 carbon atoms on a terminal side.

In addition, the hydrophilic part is not particularly limited as long as it has the above-described hydrophilic group, and is preferably a side chain having a polyoxyalkylene group, and more preferably a side chain having a polyoxyethylene group.

Examples of a monomer that forms such a hydrophobic part include those shown below.

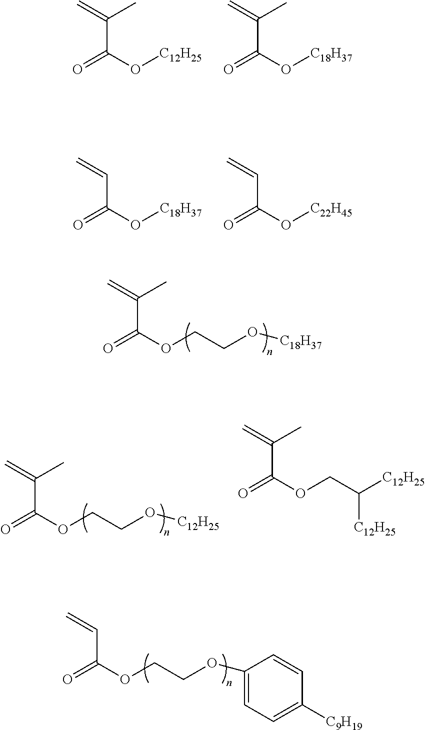

In addition, examples of the monomer that forms such a hydrophilic part include those shown below.

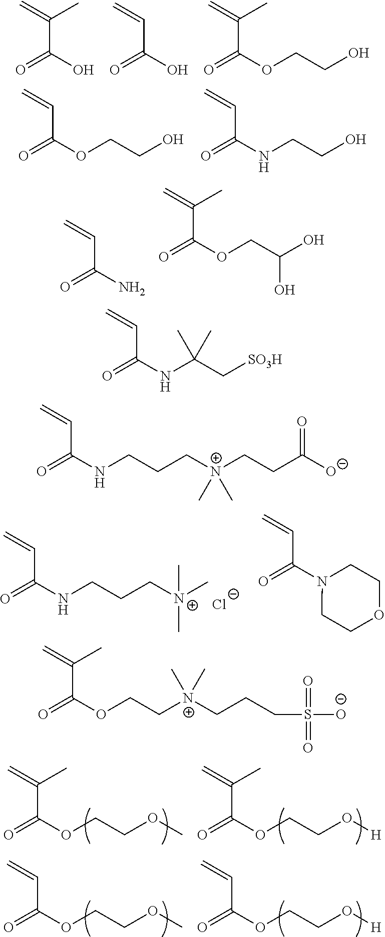

In the present invention, a content of the specific additive included in the composition for forming an alignment film is preferably 0.1% to 10% by mass, more preferably 0.15% to 8% by mass, and still more preferably 0.20% to 5% by mass with respect to a mass of the specific polymer which will be described later.

Similarly, the content of the specific additive included in an alignment film thus formed is preferably 0.1% to 10% by mass, more preferably 0.15% to 8% by mass, and still more preferably 0.20% to 5% by mass with respect to the mass of the specific polymer which will be described later.

### Specific Polymer

The specific polymer included in the composition for forming an alignment film is a polymer having no alkyl group having 5 to 29 carbon atoms.

Here, the specific polymer is not particularly limited as long as it has no alkyl group having 5 to 29 carbon atoms, and examples thereof include a polyvinyl alcohol (polyvinyl acetic acid), a polystyrene, a polyester, a polyamide, a polysulfone, a polyether sulfone, a polyimide, a polyacrylic acid, a poly(meth)acrylate, a polyacetal, a polycarbonate, and a modified polymer thereof.

In addition, a weight-average molecular weight of the specific polymer is not particularly limited, and is preferably 5,000 to 200,000, and more preferably 10,000 to 70,000.

Here, the weight-average molecular weight in the present invention is a value measured by gel permeation chromatography (GPC) under the following conditions.
Solvent (eluent): Tetrahydrofuran (THF)
Device name: TOSOH HLC-8320GPC
Columns: Three columns of TOSOH TSKgel Super HZM-H (4.6 mm×15 cm) linked to each other in use
Column temperature: 40° C.
Sample concentration: 0.1% by mass
Flow rate: 1.0 ml/min
Calibration curve: Calibration curve obtained from 7 samples of TSK standard polystyrene Mw of 2,800,000 to 1,050 (Mw/Mn=1.03 to 1.06) manufactured by Tosoh Corporation in use

In the present invention, the specific polymer is preferably the polyvinyl alcohol or the modified polyvinyl alcohol for a reason that the aligning properties of the liquid crystal compound in the optically anisotropic layer are further improved and the occurrence of bright point defects in the optical film can be further suppressed.

Here, the polyvinyl alcohol is obtained by hydrolyzing all acetyl groups included in a vinyl acetate polymer into hydroxyl groups (saponification) with a strong base such as sodium hydroxide.

In addition, the modified polyvinyl alcohol is obtained by substituting the hydroxyl group with another substituent (for example, an acetyl group, a carboxy group, and an amide group).

Examples of the modified polyvinyl alcohol include a polymer having a repeating unit represented by Formula (1) and a repeating unit represented by Formula (2), and a polymer having a repeating unit represented by Formula (1), a repeating unit represented by Formula (2), and a repeating unit represented by Formula (3).

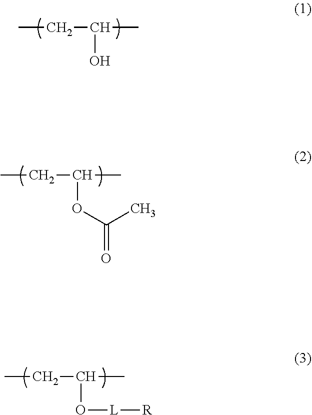

In Formula (3), L represents —CO—, —O—, —S—, —C(═S)—, —CR¹R²—, —CR³═CR⁴—, —NR⁵—, or a divalent linking group formed by a combination of two or more of these groups, and R¹ to R⁵ each independently represent a hydrogen atom, a fluorine atom, or an alkyl group having 1 to 5 carbon atoms.

R represents an alkyl group having 1 to 5 carbon atoms, a phenyl group, a heteroaryl group, a polymerizable group, or a group formed by combination of two or more of these groups.

The alkyl group may be linear or branched. In addition, the alkyl group may have a cyclic structure.

The number of carbon atoms in the alkyl group is not particularly limited as long as it is 1 to 5, but is preferably 2 to 4.

The alkyl group may have a hydroxyl group. That is, the alkyl group may have a hydroxyl group as a substituent.

In addition, the alkyl group may include a heteroatom. Examples of the heteroatom include an oxygen atom, a nitrogen atom, and a sulfur atom. In a case where the alkyl group includes a heteroatom, for example, an aspect in which the alkyl group includes a divalent linking group such as —O—, —CO—O—, —CO—NH—, —SO₂—, —SO₂—O—, or —SO₂—NH— is exemplified.

As the heteroaryl group, a heteroaryl group consisting of a 5-, 6-, or 7-membered ring or a fused ring thereof is preferable. Examples of the heteroatom of the heteroaryl group include an oxygen atom, a nitrogen atom, and a sulfur atom. Specific examples of the ring constituting the heteroaryl group include a furan ring, a thiophene ring, a pyrrole ring, a pyrroline ring, a pyrrolidine ring, an oxazole ring, an isoxazole ring, a thiazole ring, an isothiazole ring, an imidazole ring, and an imidazoline ring.

Examples of the polymerizable group include a polymerizable group represented by any of Formulae (P-1) to (P-20) described in a polymerizable liquid crystal compound which will be described later.

A content of the repeating unit represented by Formula (1) is not particularly limited, but is preferably 76.0% to 95.0% by mole, and more preferably 78.0% to 91.0% by mole with respect to all the repeating units in the modified polyvinyl alcohol.

A content of the repeating unit represented by Formula (2) is not particularly limited, but is preferably more than 0% by mole and 25.0% by mole or less, and more preferably 1.0% to 21.0% by mole with respect to all the repeating units in the modified polyvinyl alcohol.

In a case where the modified polyvinyl alcohol has the repeating unit represented by Formula (3), a content of the repeating unit represented by Formula (3) is not particularly limited, but is preferably 0.5% to 14.0% by mole with respect to all the repeating units in the modified polyvinyl alcohol.

### Other Components

The composition for forming an alignment film may contain components other than the above-mentioned specific additive and specific polymer.

### Polymerization Initiator

In a case where the above-mentioned specific polymer (for example, the modified polyvinyl alcohol) has a polymerizable group (for example, a (meth)acryloyl group), it is preferable that the composition for forming an alignment film contains a polymerization initiator.

The polymerization initiator is not particularly limited, and examples thereof include a thermal polymerization initiator and a photopolymerization initiator, depending on a type of the polymerization reaction.

As the polymerization initiator, a photopolymerization initiator capable of initiating a polymerization reaction upon irradiation with ultraviolet rays is preferable.

Examples of the photopolymerization initiator include an α-carbonyl compound, acyloin ether, an α-hydrocarbon-substituted aromatic acyloin compound, a polynuclear quinone compound, a combination of a triarylimidazole dimer and p-aminophenyl ketone, an acridine and phenazine compound, an oxadiazole compound, and an acylphosphine oxide compound.

### Curing Agent

The composition for forming an alignment film may contain a curing agent, in addition to the above-mentioned specific additive.

Examples of the curing agent include a carboxylic acid compound (for example, a citric acid ester) and an aldehyde compound (for example, glutaraldehyde and glyoxal).

### Solvent

From the viewpoint of workability and the like in a case of forming an alignment film, it is preferable that the composition for forming an alignment film contains a solvent.

Examples of the solvent include ketones (for example, acetone, 2-butanone, methyl isobutyl ketone, cyclopentanone, and cyclohexanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethylacetamide).

The solvents may be used alone or in combination of two or more kinds thereof.

The alignment film is a film formed of the composition for forming an alignment film, including the above-mentioned specific additive and specific polymer, and a procedure for producing the same will be described in detail in an alignment film forming step in a method for producing an optical film of an embodiment of the present invention which will be described below.

A thickness of the alignment film is not particularly limited, but is preferably 0.2 to 1.0 μm, and more preferably 0.4 to 0.8 μm.

### Optically Anisotropic Layer

The optically anisotropic layer included in the optical film of the embodiment of the present invention is a layer disposed on the above-mentioned alignment film, and in the present invention, the optically anisotropic layer is a layer formed of a composition for forming an optically anisotropic layer, containing a polymerizable liquid crystal compound. More specifically, as described in detail in an optically anisotropic layer forming step in the method for producing an optical film of the embodiment of the present invention which will be described below, the optically anisotropic layer is preferably a layer formed by aligning the polymerizable liquid crystal compound in a coating film formed by applying a composition for forming an optically anisotropic layer, and fixing this state, and in this case, the optically anisotropic layer does not need to exhibit liquid crystallinity after the formation of the layer.

### Polymerizable Liquid Crystal Compound

The polymerizable liquid crystal compound included in the composition for forming an optically anisotropic layer is a liquid crystal compound having a polymerizable group.

Here, the polymerizable group is not particularly limited, but is preferably a radically polymerizable group or a cationically polymerizable group.

A known radically polymerizable group can be used as the radically polymerizable group, and suitable examples thereof include an acryloyloxy group or a methacryloyloxy group. In this case, it is known that the acryloyloxy group generally has a high polymerization rate, and from the viewpoint of improvement of productivity, the acryloyloxy group is preferable, but the methacryloyloxy group can also be used as the polymerizable group.

A known cationically polymerizable group can be used as the cationically polymerizable group, and specific examples thereof include an alicyclic ether group, a cyclic acetal group, a cyclic lactone group, a cyclic thioether group, a spiroorthoester group, and a vinyloxy group. Among these, the alicyclic ether group or the vinyloxy group is suitable, and an epoxy group, an oxetanyl group, or the vinyloxy group is particularly preferable.

Particularly preferred examples of the polymerizable group include a polymerizable group represented by any of Formulae (P-1) to (P-20).

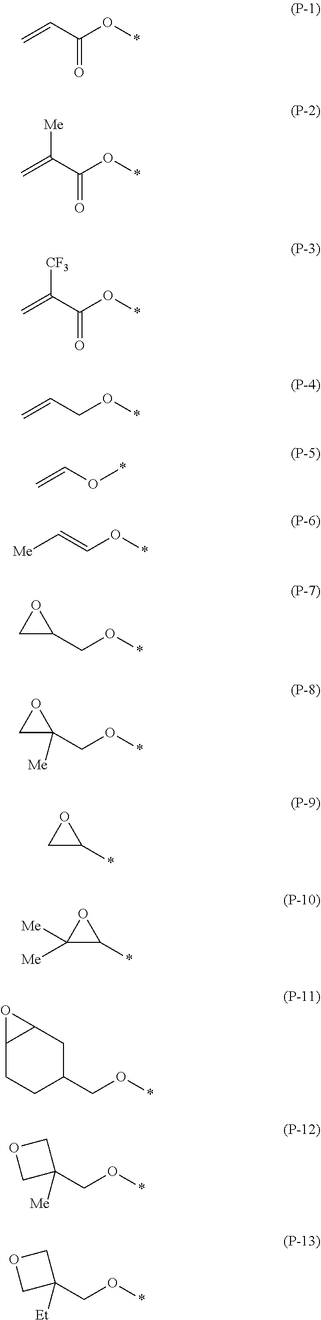

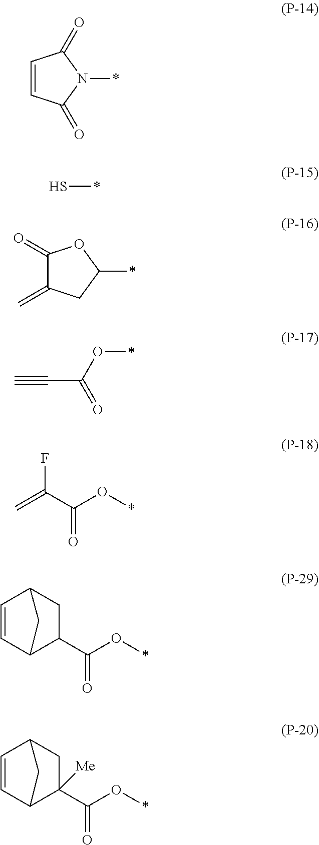

The polymerizable liquid crystal compound is not particularly limited, and examples thereof include a compound in which any one of homeotropic alignment, homogeneous alignment, hybrid alignment, or cholesteric alignment can be performed.

Here, in general, liquid crystal compounds can be classified into a rod-like type and a disk-like type according to the shape thereof. Furthermore, there are a low-molecular-weight type and a high-molecular-weight type, respectively. The term, high-molecular-weight, generally refers to having a degree of polymerization of 100 or more (Polymer Physics-Phase Transition Dynamics, by Masao Doi, page 2, published by Iwanami Shoten, Publishers, 1992). In the present invention, any liquid crystal compound can be used, and a rod-like liquid crystal compound or a discotic liquid crystal compound (disk-like liquid crystal compound) is preferable. In addition, a relatively low molecular weight liquid crystal compound which is a monomer or has a polymerization degree of less than 100 is preferable.

As the rod-like liquid crystal compound, for example, compounds described in claim 1 of JP1999-513019A (JP-H11-513019A) or paragraphs [0026] to [0098] of JP2005-289980A are preferable, and as the discotic liquid crystal compound, for example, compounds described in paragraphs [0020] to [0067] of JP2007-108732A or paragraphs to of JP2010-244038A are preferable.

A liquid crystal compound having reverse wavelength dispersibility can be used as the above-described polymerizable liquid crystal compound.

Here, in the present specification, the liquid crystal compound having “reverse wavelength dispersibility” denotes that in the measurement of an in-plane phase difference (Re) value at a specific wavelength (visible light range) of a phase difference film manufactured using the liquid crystal compound, the Re value is the same or increased as the measurement wavelength increases.

The liquid crystal compound having reverse wavelength dispersibility is not particularly limited as long as a film having reverse wavelength dispersibility can be formed as described above, and examples thereof include compounds represented by Formula (I) described in JP2008-297210A (particularly, compounds described in paragraphs [0034] to [0039]), compounds represented by Formula (1) described in JP2010-084032A (particularly, compounds described in paragraphs [0067] to [0073]), and compounds represented by Formula (1) described in JP2016-081035A (particularly, compounds described in paragraphs [0043] to [0055]).

Examples thereof further include compounds described in paragraphs [0027] to [0100] of JP2011-006360A, paragraphs [0028] to [0345] of JP2011-006361A, paragraphs [0034] to [0298] of JP2012-207765A, paragraphs [0016] to [0345] of JP2012-077055A, paragraphs [0017] to [0072] of WO12/141245A, paragraphs [0021] to [0088] of WO12/147904A, and paragraphs [0028] to [0115] of WO14/147904A.

### Polymerization Initiator

It is preferable that the composition for forming an optically anisotropic layer contains a polymerization initiator.

Examples of the polymerization initiator include those described in the above-mentioned composition for forming an alignment film.

### Solvent

From the viewpoint of workability and the like in a case of forming an optically anisotropic layer, it is preferable that the composition for forming an optically anisotropic layer contains a solvent.

Examples of the solvent include those described in the above-mentioned composition for forming an alignment film.

### Leveling Agent

From the viewpoint of keeping a surface of the optically anisotropic layer smooth and easily controlling the alignment, it is preferable that the composition for forming an optically anisotropic layer includes a leveling agent.

As such a leveling agent, a fluorine-based leveling agent or a silicon-based leveling agent is preferable for a reason that it has a high leveling effect on the addition amount, and the fluorine-based leveling agent is more preferable from the viewpoint that it is less likely to cause bleeding (bloom or bleed).

Examples of the leveling agent include the compounds described in paragraphs [0079] to [0102] of JP2007-069471A, the compound represented by General Formula (I) described in JP2013-047204A (in particular, the compounds described in paragraphs [0020] to [0032]), the compound represented by General Formula (I) described in JP2012-211306A (in particular, the compounds described in paragraphs [0022] to [0029]), the liquid crystal alignment accelerator represented by General Formula (I) described in JP2002-129162A (in particular, the compounds described in paragraphs [0076] to [0078] and [0082] to [0084]), and the compounds represented by General Formulae (I), (II), and (III) described in JP2005-099248A (in particular, the compounds described in paragraphs [0092] to [0096]). Furthermore, the leveling agent may also function as an alignment control agent which will be described later.

### Alignment Control Agent

The composition for forming an optically anisotropic layer may include an alignment control agent, as necessary.

With the alignment control agent, various alignment states such as homeotropic alignment (vertical alignment), tilt alignment, hybrid alignment, and cholesteric alignment can be formed, in addition to the homogeneous alignment, and specific alignment states can be controlled and realized more uniformly and more accurately.

As an alignment control agent that accelerates the homogeneous alignment, for example, a low-molecular-weight alignment control agent and a high-molecular-weight alignment control agent can be used.

With regard to the low-molecular-weight alignment control agent, reference can be made to the description in, for example, paragraphs [0009] to [0083] of JP2002-20363A, paragraphs [0111] to [0120] of JP2006-106662A, and paragraphs [0021] to [0029] of JP2012-211306A, the contents of which are hereby incorporated by reference.

In addition, with regard to the high-molecular-weight alignment control agent, reference can be made to the description in, for example, paragraphs [0021] to [0057] of JP2004-198511A and paragraphs [0121] to [0167] of JP2006-106662A, the contents of which are hereby incorporated by reference.

In addition, examples of an alignment control agent that forms or accelerates the homeotropic alignment include a boronic acid compound and an onium salt compound. With regard to the alignment control agent, reference can be made to the description in the compounds described in paragraphs [0023] to [0032] of JP2008-225281A, paragraphs [0052] to [0058] of JP2012-208397A, paragraphs [0024] to [0055] of JP2008-026730A, and paragraphs [0043] to [0055] of JP2016-193869A, the contents of which are hereby incorporated by reference.

On the other hand, the cholesteric alignment can be realized by adding a chiral agent to the composition for forming an optically anisotropic layer of the embodiment of the present invention, and it is possible to control a direction of revolution of the cholesteric alignment by its chiral direction.

Incidentally, a pitch of the cholesteric alignment may be controlled in accordance with the alignment restricting force of the chiral agent.

In a case where the composition for forming an optically anisotropic layer includes the alignment control agent, a content of the alignment control agent is preferably 0.01% to 10% by mass, and more preferably 0.05% to 5% by mass with respect to a total solid content mass in the composition. In a case where the content is within the range, it is possible to obtain a uniform and highly transparent cured product, in which precipitation or phase separation, alignment defects, and the like are suppressed while a desired alignment state is achieved.

### Other Components

The composition for forming an optically anisotropic layer may include components other than the above-described components. Examples of such other components include a surfactant, a tilt angle control agent, an alignment assistant, a plasticizer, and a crosslinking agent. In addition, the composition may include an ionic compound, a conductive polymer, or the like as an antistatic agent.

The optically anisotropic layer is a film formed of the above-mentioned composition for forming an optically anisotropic layer, and a procedure for producing the same will be described in detail in an optically anisotropic layer forming step in a method for producing an optical film of an embodiment of the present invention which will be described below.

A thickness of the optically anisotropic layer is not particularly limited, but from the viewpoint of reducing the thickness of a device, the thickness is preferably 0.7 to 2.5 μm, and more preferably 0.9 to 2.2 μm.

The alignment state of the polymerizable liquid crystal compound in the optically anisotropic layer may be any of horizontal alignment, vertical alignment, tilt alignment, and twist alignment, and it is preferable that the polymerizable liquid crystal compound is immobilized in a state of being horizontally aligned with respect to a main surface of the optically anisotropic layer.

Furthermore, in the present specification, the “horizontal alignment” means that the main surface of the optically anisotropic layer and the major axis direction of the polymerizable liquid crystal compound are parallel to each other. Incidentally, it is not required for the both to be strictly parallel, and in the present specification, the expression means that the both are aligned at an angle formed by the major axis direction of the polymerizable liquid crystal compound and the main surface of the optically anisotropic layer of less than 10°.

In the optically anisotropic layer, the angle formed by the major axis direction of the polymerizable liquid crystal compound and the main surface of the optically anisotropic layer is preferably 0° to 5°, more preferably 0° to 3°, and still more preferably 0° to 2°.

The optically anisotropic layer is more preferably a positive A plate or a positive C plate, and still more preferably the positive A plate.

Here, the positive A plate (A plate which is positive) and the positive C plate (C plate which is positive) are defined as follows.

In a case where a refractive index in a film in-plane slow axis direction (in a direction in which an in-plane refractive index is maximum) is defined as nx, a refractive index in an in-plane direction orthogonal to the in-plane slow axis is defined as ny, and a refractive index in a thickness direction is defined as nz, the positive A plate satisfies the relationship of Expression (A1) and the positive C plate satisfies the relationship of Expression (C1). Furthermore, the positive A plate has an Rth showing a positive value and the positive C plate has an Rth showing a negative value.

$$nx > ny \approx nz \qquad Expression ( A1 )$$

$$nz > nx \approx ny \qquad Expression ( C1 )$$

Furthermore, the symbol, “≈”, encompasses not only a case where both sides are completely the same as each other but also a case where the both are substantially the same as each other.

In the expression, “substantially the same”, with regard to the positive A plate, for example, a case where (ny−nz)×d (in which d is the thickness of a film) is −10 to 10 nm, and preferably −5 to 5 nm is also included in “ny≈nz”, and a case where (nx−nz)×d is −10 to 10 nm, and preferably −5 to 5 nm is also included in “nx≈nz”. In addition, with regard to the positive C plate, for example, a case where (nx−ny)×d (in which d is the thickness of a film) is 0 to 10 nm, and preferably 0 to 5 nm is also included in “nx≈ny”.

In a case where the optically anisotropic layer is a positive A plate, the Re(550) is preferably 100 to 180 nm, more preferably 120 to 160 nm, still more preferably 130 to 150 nm, and particularly preferably 130 to 145 nm, from the viewpoint that the optically anisotropic layer functions as a λ/4 plate.

Here, the “λ/4 plate” is a plate having a λ/4 function, specifically, a plate having a function of converting a linearly polarized light at a certain specific wavelength into a circularly polarized light (or converting a circularly polarized light to a linearly polarized light).

### Support

The optical film of the embodiment of the present invention may have a support for supporting the above-mentioned alignment film.

The type of the support is not particularly limited, and a known support can be used. In particular, a transparent support is preferable. Furthermore, the transparent support is intended to be a support in which the transmittance of visible light is 60% or more, and the transmittance is preferably 80% or more, and more preferably 90% or more.

Examples of the support include a glass substrate and a polymer film.

Examples of the material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer; polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; and polymers obtained by mixing these polymers.

In addition, the support is preferably a peelable support.

### Optically Anisotropic Layer

The optically anisotropic layer of the embodiment of the present invention is a layer formed of a composition for forming an optically anisotropic layer, containing a polymerizable liquid crystal compound.

In addition, in the optically anisotropic layer of the embodiment of the present invention, 1 to 80 bright point defects of 100 μm or more are present in 10 m², and the core of the bright point defect contains an additive having an alkyl group having 5 to 29 carbon atoms and a polymer having no alkyl group having 5 to 29 carbon atoms.

Here, the number of the bright point defects having a size of 100 μm or more that are present in the optically anisotropic layer can be confirmed by the following method.

First, two polarizing plates are overlapped on a Schaukasten in a crossed-nicols state, an optical film (observation area: 100×130 cm) having an optically anisotropic layer is interposed between the two polarizing plates, and light is transmitted from the Schaukasten.

Next, the optical film is observed from the polarizing plate using a loupe, and defects having a diameter of 100 μm or more are marked.

Next, a cross-section is obtained by cutting with a microtome to pass through the center of the marked defect, observation of the cross-section with an optical microscope in a cross-sectional direction is carried out, and defects in which foreign matters are observed in the optically anisotropic layer are counted.

As described above, the cores of the bright point defects present in the optically anisotropic layer of the embodiment of the present invention contain an additive having an alkyl group having 5 to 29 carbon atoms and a polymer having no alkyl group having 5 to 29 carbon atoms.

Here, the additive and the polymer are the same as the specific additive and the specific polymer described in the above-mentioned alignment film, respectively.

That is, it is considered that the cores of the bright point defects present in the optically anisotropic layer of the embodiment of the present invention are those in which the alignment film scraps that have been slightly generated in a case of subjecting the alignment film to a rubbing treatment migrate onto the optically anisotropic layer side during the formation of the optically anisotropic layer.

### Composition for Forming Alignment Film

The composition for forming an alignment film of an embodiment of the present invention is a composition containing an additive having an alkyl group having 5 to 29 carbon atoms and a polymer having no alkyl group having 5 to 29 carbon atoms.

Here, the additive and the polymer are the same as the specific additive and the specific polymer described in the above-mentioned alignment film, respectively.

### Method for Producing Optical Film

The method of producing an optical film of an embodiment of the present invention is a method for producing an optical film, having an alignment film forming step of forming an alignment film on a support, using the above-mentioned composition for forming an alignment film, a rubbing step of subjecting the alignment film to a rubbing treatment, and an optically anisotropic layer forming step of forming an optically anisotropic layer on the rubbing-treated alignment film, using a composition for forming an optically anisotropic layer, containing a polymerizable liquid crystal compound.

Hereinafter, a procedure of each step will be described in detail.

### Alignment Film Forming Step

The alignment film forming step is a step of forming an alignment film on a support, using a composition for forming an alignment film.

The composition for forming an alignment film and the support used in the present step are as described above.

Examples of one aspect of a specific procedure for forming the alignment film include a method for forming an alignment film by applying a composition for forming an alignment film onto a support to form a coating film on the support, and subjecting the coating film to a rubbing treatment.

A method for applying the composition for forming an alignment film onto the support is not particularly limited, and examples thereof include a wire bar coating method, an extrusion coating method, a direct gravure coating method, a reverse gravure coating method, and a die coating method.

After the composition for forming an alignment film is applied onto the support, the support to which the composition for forming an alignment film is applied may be subjected to a drying treatment to remove the solvent, as necessary.

### Rubbing Step

The rubbing step is a step of subjecting the alignment film to a rubbing treatment.

Here, as the rubbing treatment, a treatment method widely adopted as a liquid crystal alignment treatment step of a liquid crystal display device can be applied. That is, a method for obtaining alignment by rubbing a surface of an alignment film in a given direction, using paper, gauze, felt, rubber, nylon, polyester fibers, or the like is used.

### Optically Anisotropic Layer Forming Step

The optically anisotropic layer forming step is a step of forming an optically anisotropic layer on the rubbing-treated alignment film, using the composition for forming an optically anisotropic layer.

Examples of one aspect of a specific procedure for forming the optically anisotropic layer include a method for forming the optically anisotropic layer by applying a composition for forming an optically anisotropic layer onto an alignment film to form a coating film on the alignment film, aligning the polymerizable liquid crystal compound in the coating film, and then subjecting the coating film to a curing treatment.

Examples of the method for applying the composition for forming an optically anisotropic layer onto the alignment film include the same method as the above-mentioned method of applying the composition for forming an alignment film.

After applying the composition for forming an optically anisotropic layer onto the alignment film, the solvent may be removed by optionally drying the support onto which the composition for forming an optically anisotropic layer has been applied.

A method for aligning the polymerizable liquid crystal compound in the coating film (alignment treatment) is not particularly limited, and examples thereof include a method of heating the coating film and a method of drying the coating film at room temperature. In a case of a thermotropic liquid crystal compound, a liquid crystal phase formed by the alignment treatment can be generally transferred by a change in the temperature. In a case of a lyotropic liquid crystal compound, the liquid crystal phase can also be transferred according to a compositional ratio such as the amount of a solvent.

Furthermore, the condition in a case of heating the coating film is not particularly limited, but the heating temperature is preferably 50° C. to 150° C., and the heating time is preferably 10 seconds to 5 minutes.

Next, the coating film in which the polymerizable liquid crystal compound is aligned is cured to form an optically anisotropic layer.

A method for the curing treatment is not particularly limited, examples thereof include a light irradiation treatment and a heating treatment, and the light irradiation is preferable.

The type of light during the exposure is not particularly limited, but ultraviolet light is preferable.

The irradiation amount at the time of the exposure is not particularly limited, and is preferably 10 mJ/cm² to 50 J/cm², and more preferably 20 mJ/cm² to 5 J/cm². In addition, the polymerization may be carried out under a heating condition in order to accelerate the polymerization reaction.

### Polarizing Plate

A polarizing plate of an embodiment of the present invention is a polarizing plate including the optical film of the embodiment of the present invention or the optically anisotropic layer of the embodiment of the present invention (hereinafter simply referred to as “the optical film or the like of the embodiment of the present invention” in the description of the polarizing plate of the present invention), and a polarizer.

### Polarizer

The polarizer contained in the polarizing plate of the embodiment of the present invention is not particularly limited as long as it is a member having a function of converting light into specific linearly polarized light, and an absorptive type polarizer and a reflective type polarizer, which are known in the related art, can be used.

An iodine-based polarizer, a dye-based polarizer using a dichroic dye, a polyene-based polarizer, or the like is used as the absorptive type polarizer. The iodine-based polarizer and the dye-based polarizer are classified into a coating type polarizer and a stretching type polarizer, any of which can be applied, but a polarizer which is manufactured by allowing polyvinyl alcohol to adsorb iodine or a dichroic dye and performing stretching is preferable.

In addition, examples of a method of obtaining a polarizer by carrying out stretching and dying in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

Examples of the coating type polarizer include those in WO2018/124198A, WO2018/186503A, WO2019/132020A, WO2019/132018A, WO2019/189345A, JP2019-197168A, JP2019-194685A, and JP2019-139222A, and known techniques relating to these polarizers can also be preferably used.

A polarizer in which thin films having different birefringence are laminated, a wire grid-type polarizer, a polarizer having a combination of a cholesteric liquid crystal having a selective reflection range, a ¼ wavelength plate, and the like is used as the reflective type polarizer.

Among these, from the viewpoint of more excellent adhesiveness, a polarizer including a polyvinyl alcohol-based resin (a polymer including —CH₂—CHOH— as a repeating unit; in particular, at least one selected from the group consisting of a polyvinyl alcohol and an ethylene-vinyl alcohol copolymer) is preferable.

In addition, from the viewpoint of imparting crack resistance, the polarizer may have a depolarization unit formed along the opposite end edges. Examples of the depolarization unit include JP2014-240970A.

In addition, the polarizer may have non-polarizing parts arranged at predetermined intervals in the longitudinal direction and/or the width direction. The non-polarizing part is a decolorized part which is partially decolorized. The arrangement pattern of the non-polarizing parts can be appropriately set according to a purpose. For example, the non-polarizing parts are arranged at a position corresponding to a camera unit of an image display device in a case where a polarizer is cut (cut, punched, or the like) to a predetermined size in order to be attached to the image display device in a predetermined size. Examples of the arrangement pattern of the non-polarizing parts include those in JP2016-27392A.

A thickness of the polarizer is not particularly limited, but is preferably 3 to 60 μm, more preferably 3 to 30 μm, and still more preferably 3 to 10 μm.

The polarizing plate of the embodiment of the present invention may have another optical film, a protective film which will be described later, or another functional layer, in addition to a polarizer such as the optical film of the embodiment of the present invention. The function of the functional layer is not particularly limited, and may be, for example, a layer having functions of an adhesive layer, a stress relaxing layer, a planarizing layer, an antireflection layer, a refractive index adjusting layer, and an ultraviolet absorbing layer.

The protective film may be used on both sides of the polarizer, or may be used on only one side of the polarizer.

In addition, in a case where the protective film is provided on the same side as the optical film or the like of the embodiment of the present invention, it may be arranged between the polarizer and the optical film or the like, or on the side of the optical film and the like opposite to the polarizer, or the like, via a pressure sensitive adhesive or an adhesive.

The polarizing plate can be used as a circularly polarizing plate in a case where the optically anisotropic layer contained in the optical film of the embodiment of the present invention or the optically anisotropic layer of the embodiment of the present invention described above is a λ/4 plate (positive A plate).

In a case where the polarizing plate is used as the circularly polarizing plate, the above-mentioned optically anisotropic layer is used as a λ/4 plate (positive A-plate), and an angle between the slow axis of the λ/4 plate and the absorption axis of a polarizer which will be described later is preferably 30° to 60°, more preferably 40° to 50°, still more preferably 42° to 48°, and particularly preferably 45°.

Here, the “slow axis” of the λ/4 plate means a direction in which the refractive index in the plane of the λ/4 plate is maximum, and the “absorption axis” of the polarizer means a direction in which the absorbance is highest.

In addition, the polarizing plate can also be used as an optical compensation film of an in-plane switching (IPS) mode or fringe-field switching (FFS) mode liquid crystal display device.

In a case where the polarizing plate is used as an optical compensation film for an IPS mode or FFS mode liquid crystal display device, it is preferable that the above-mentioned optically anisotropic layer is used as at least one plate of a laminate of a positive A-plate or a positive C-plate, an angle formed by the slow axis of the positive A-plate layer and the absorption axis of a polarizer are orthogonal or parallel, and specifically, it is more preferable that an angle formed by the slow axis of the positive A-plate layer and the absorption axis of the polarizer is 0° to 5° or 85° to 95°.

In addition, in a case where the optical compensation film has a polarizer, a positive C-plate, and a positive A-plate laminated in this order, it is more preferable that an angle formed by the slow axis of the positive A-plate and the absorption axis of the polarizer is parallel to each other.

Similarly, in a case where the optical compensation film has a polarizer, a positive A-plate, and a positive C-plate laminated in this order, it is more preferable that an angle formed by the slow axis of the positive A-plate and the absorption axis of the polarizer is orthogonal to each other.

In a case where the polarizing plate of the embodiment of the present invention is used in a liquid crystal display device which will be described later, it is preferable that an angle formed by the slow axis of the optically anisotropic layer and the absorption axis of a polarizer is parallel or orthogonal.

Furthermore, in the present specification, a term “parallel” does not require that the both are strictly parallel, but means that an angle between one and the other is less than 10°. In addition, in the present specification, a term “orthogonal” does not require that the both are strictly orthogonal, but means that the angle between one and the other is more than 80° and less than 100°.

### Protective Film

A material for the protective film is not particularly limited, and examples thereof include a polyacrylic resin film such as a cellulose acylate film (for example, a cellulose triacetate film, a cellulose diacetate film, a cellulose acetate butyrate film, and a cellulose acetate propionate film), and a polymethyl methacrylate, polyolefins such as polyethylene and polypropylene, polyester-based resin films such as polyethylene terephthalate and polyethylene naphthalate, a polyether sulfone film, a polyurethane-based resin film, a polyester film, a polycarbonate film, a polysulfone film, a polyether film, a polymethylpentene film, a polyether ketone film, a (meth)acrylonitrile film, a polyolefin, a polymer with an alicyclic structure (norbornene-based resin (ARTON: product name, manufactured by JSR Corporation) and an amorphous polyolefin (ZEONEX: product name, manufactured by Nippon Zeon Co., Ltd.)). Among these, the cellulose acylate film is preferable.

The optical characteristics of the protective film are not particularly limited, but in a case where the protective film is provided on the same side as the optical film or the like of the embodiment of the present invention, it is preferable to satisfy the following expression.

$$0 nm \leq Re ( 550 ) \leq 10 nm$$

$$- 40 nm \leq Rth ( 550 ) \leq 40 nm$$

### Pressure Sensitive Adhesive Layer

In the polarizing plate, a pressure sensitive adhesive layer may be disposed between the optical film of the embodiment of the present invention and a polarizer.

Examples of a material forming the pressure-sensitive adhesive layer include a member formed of a substance in which a ratio (tan δ=G″/G′) between a storage elastic modulus G′ and a loss elastic modulus G″, each measured with a dynamic viscoelastometer, is 0.001 to 1.5, in which a so-called pressure-sensitive adhesive and a readily creepable substance are included. Examples of the pressure-sensitive adhesive include a polyvinyl alcohol-based pressure-sensitive adhesive, but the pressure-sensitive adhesive is not limited thereto.

### Adhesive Layer

In the polarizing plate, an adhesive layer may be disposed between the optical film of the embodiment of the present invention and a polarizer.

As the adhesive layer, a curable adhesive composition which is cured by irradiation with active energy rays or heating is preferable.

Examples of the curable adhesive composition include a curable adhesive composition containing a cationically polymerizable compound and a curable adhesive composition containing a radically polymerizable compound.

A thickness of the adhesive layer is preferably 0.01 to 20 μm, more preferably 0.01 to 10 μm, and still more preferably 0.05 to 5 μm. In a case where the thickness of the adhesive layer is within this range, floating or peeling does not occur between the protective layer or optically anisotropic layer and the polarizer, which are laminated, and an adhesive force having no problem in practical use can be obtained. In addition, the thickness of the adhesive layer is preferably 0.4 μm or more from the viewpoint that the generation of air bubbles can be suppressed.

Moreover, from the viewpoint of durability, a bulk water absorption rate of the adhesive layer may be adjusted to 10% by mass or less, and is preferably 2% by mass or less. The bulk water absorption rate is measured according to the water absorption rate testing method described in JIS K 7209.

With regard to the adhesive layer, reference can be made to, for example, the description in paragraphs [0062] to [0080] of JP2016-35579A, the contents of which are incorporated herein by reference.

### Easy Adhesion Layer

In the polarizing plate, an easy adhesion layer may be disposed between the optical film of the embodiment of the present invention and a polarizer.

A storage elastic modulus of the easy adhesion layer at 85° C. is preferably 1.0×10⁶ Pa to 1.0×10⁷ Pa from the viewpoints that the adhesiveness between the optical film or the like of the embodiment of the present invention and the polarizer is excellent and the generation of cracks in the polarizer is suppressed. Examples of the constituent material of the easy adhesion layer include a polyolefin-based component and a polyvinyl alcohol-based component. A thickness of the easy adhesion layer is preferably 500 nm to 1 μm.

With regard to the easy adhesion layer, reference can be made to, for example, the description in paragraphs [0048] to [0053] of JP2018-36345A, the contents of which are incorporated herein by reference.

### Image Display Device

The image display device of an embodiment of the present invention is an image display device having the optical film of the embodiment of the present invention or the optically anisotropic layer of the embodiment of the present invention.

A display element used in the image display device is not particularly limited, and examples thereof include a liquid crystal cell, an organic electroluminescent (hereinafter simply referred to as “electroluminescence (EL)”) display panel, and a plasma display panel. Among those, the liquid crystal cell and the organic EL display panel are preferable, and the liquid crystal cell is more preferable.

That is, as the image display device, a liquid crystal display device using a liquid crystal cell as a display element or an organic EL display device using an organic EL display panel as a display element is preferable, and the liquid crystal display device is more preferable.

### Liquid Crystal Display Device

A liquid crystal display device which is an example of the image display device is a liquid crystal display device having the above-mentioned polarizing plate and a liquid crystal cell.

Furthermore, it is preferable that the above-mentioned polarizing plate is used as the polarizing plate of the front side, and it is more preferable that the above-mentioned polarizing plate is used as the polarizing plates on the front and rear sides, among the polarizing plates provided on both sides of the liquid crystal cell.

Hereinafter, the liquid crystal cell constituting the liquid crystal display device will be described in detail.

### Liquid Crystal Cell

The liquid crystal cell used in the liquid crystal display device is in a vertical alignment (VA) mode, an optically compensated bend (OCB) mode, an in-plane-switching (IPS) mode, a fringe-field-switching (FFS) mode, or a twisted nematic (TN) mode is preferred, but is not limited to these.

In a TN mode liquid crystal cell, rod-like liquid crystal molecules are substantially horizontally aligned and are twist-aligned at 60° to 120° during no voltage application thereto. The TN mode liquid crystal cell is most often used in a color TFT liquid crystal display device, and described in numerous documents.

In a VA mode liquid crystal cell, rod-like liquid crystal molecules are substantially vertically aligned during no voltage application thereto. Examples of the VA mode liquid crystal cell include (1) a VA mode liquid crystal cell in the narrow sense of the word, in which rod-like liquid crystal molecules are substantially vertically aligned during no voltage application thereto, but are substantially horizontally aligned during voltage application thereto (described in JP1990-176625A (JP-H02-176625A)), (2) an MVA mode liquid crystal cell in which the VA mode is multi-domained for viewing angle enlargement (described in SID97, Digest of tech. Papers (preprint), 28 (1997) 845), (3) a liquid crystal cell in a mode (n-ASM mode) in which rod-like liquid crystal molecules are substantially vertically aligned during no voltage application thereto and are multi-domain-aligned during voltage application thereto (described in Seminar of Liquid Crystals of Japan, Papers (preprint), 58-59 (1998)), and (4) a survival mode liquid crystal cell (announced in LCD International 98). In addition, the liquid crystal cell in the VA mode may be any of a patterned vertical alignment (PVA) type, an optical alignment type, and a polymer-sustained alignment (PSA) type. Details of these modes are specifically described in JP2006-215326A and JP2008-538819A.

In an IPS mode liquid crystal cell, rod-like liquid crystal molecules are aligned substantially parallel with respect to a substrate, and application of an electric field parallel to the substrate surface causes the liquid crystal molecules to respond planarly. The IPS mode displays black in a state where no electric field is applied and a pair of upper and lower polarizing plates have absorption axes which are orthogonal to each other. A method of improving the view angle by reducing light leakage during black display in an oblique direction using an optical compensation sheet is disclosed in JP1998-54982A (JP-H10-54982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

### Organic EL Display Device

Examples of the organic EL display device which is an example of the image display device include an aspect which includes, from the visible side, a polarizer, a λ/4 plate (a positive A plate) including the above-mentioned optically anisotropic layer, and an organic EL display panel in this order.

Furthermore, the organic EL display panel is a display panel composed of an organic EL device in which an organic light emitting layer (organic electroluminescent layer) is sandwiched between electrodes (between a cathode and an anode). The configuration of the organic EL display panel is not particularly limited but a known configuration is adopted.

### EXAMPLES

Hereinbelow, the present invention will be described in more detail with reference to Examples. The materials, the amounts of materials used, the proportions, the treatment details, the treatment procedure, and the like shown in Examples below can be appropriately modified as long as the modifications do not depart from the spirit of the present invention. Therefore, the scope of the present invention should not be construed as being limited to Examples shown below.

### Example 1

### Manufacture of Cellulose Acylate Film (Support)

A cellulose acylate dope with the following composition was put into a mixing tank, stirred, and further heated at 90° C. for 10 minutes.

Thereafter, the obtained composition was filtered through filter paper having an average pore size of 34 μm and a sintered metal filter having an average pore size of 10 μm, thereby preparing a dope.

The concentration of solid contents of the dope is 23.5% by mass, the amount of the plasticizer added is a proportion relative to cellulose acylate, and the solvent of the dope is methylene chloride/methanol/butanol=81/18/1 (in terms of a mass ratio).

Cellulose acylate dope

| | |
|---|---|
| Cellulose acylate (acetyl substitution degree: 2.86, | 100 parts by mass |
| viscosity-average polymerization degree: 310) | |
| Sugar ester compound 1 (represented by | 6.0 parts by mass |
| Chemical Formula (S4)) | |
| Sugar ester compound 2 (represented by | 2.0 parts by mass |
| Chemical Formula (S5)) | |
| Silica particle dispersion (AEROSIL R972, | 0.1 parts by mass |
| manufactured by Nippon Aerosil Co., Ltd.) | |
| Solvent (methylene chloride/methanol/butanol) | |

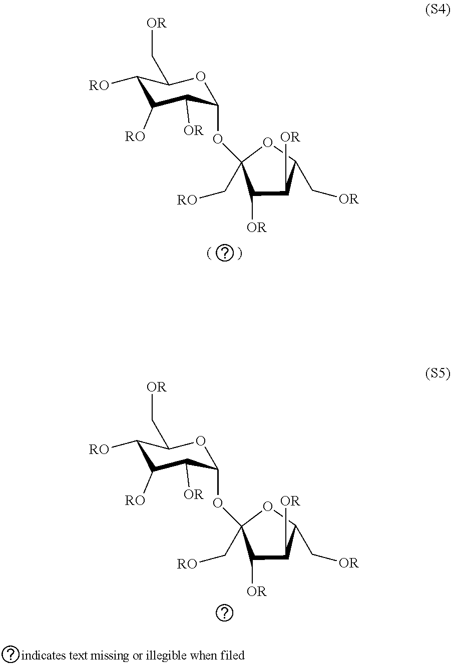

The dope prepared above was cast using a drum film forming machine.

Specifically, the dope was cast from a die such that the dope was in contact with a metal support cooled to 0° C., and then the obtained web (film) was stripped off. Furthermore, the drum was made of SUS.

Next, the web (film) obtained by casting was peeled off from the drum and dried in a tenter device for 20 minutes using a tenter device such that both ends of the web were clipped with clips and transported at 30° C. to 40° C. during film transport. Subsequently, the web was post-dried by zone heating while being transported using a roll.

Next, the obtained web was subjected to knurling and wound up.

### Alkali Saponification Treatment

After passing the wound web through a dielectric heating roll at a temperature of 60° C. to raise the film surface temperature to 40° C., an alkaline solution having the composition shown below was applied onto a band surface of the film using a bar coater at a coating amount of 14 ml/m², followed by heating to 110° C., and transportation under a steam type far-infrared heater manufactured by Noritake Co., Ltd. for 10 seconds. Subsequently, the film was coated with 3 ml/m² of pure water similarly using a bar coater. Next, the process of washing the film with water using a fountain coater and draining the film using an air knife was repeated three times, and the film was transported to a drying zone at 70° C. for 10 seconds and dried, thereby manufacturing an alkali saponification-treated cellulose acylate film.

Alkali Solution

| | |
|---|---|
| Potassium hydroxide | 4.7 parts by mass |
| Water | 15.8 parts by mass |
| Isopropanol | 63.7 parts by mass |
| Surfactant SF-1: C₁₄H₂₉O(CH₂CH₂O)₂₀H | 1.0 part by mass |
| Propylene glycol | 14.8 parts by mass |

### Formation of Alignment Film

The surface of the alkali saponification-treated cellulose acylate film, was continuously coated with a composition for forming an alignment film having the following composition using a #14 wire bar. The liquid was dried for 60 seconds by hot air at 60° C., and further dried for 120 seconds by hot air at 100° C. to obtain an alignment film.

Composition for forming alignment film

| | |
|---|---|
| Specific polymer: The following modified | 100 parts by mass |
| polyvinyl alcohol-1 | |
| Specific additive: Sodium dodecyl sulfate | 1.0 part by mass |
| The following photopolymerization initiator | 7.5 parts by mass |
| The following curing agent | 1.75 parts by mass |
| Water | 2,620 parts by mass |
| Methanol | 873 parts by mass |

Modified polyvinyl alcohol-1 [in the following formula, the numerical value described in each repeating unit represents a content (% by mole) of each repeating unit with respect to all repeating units]

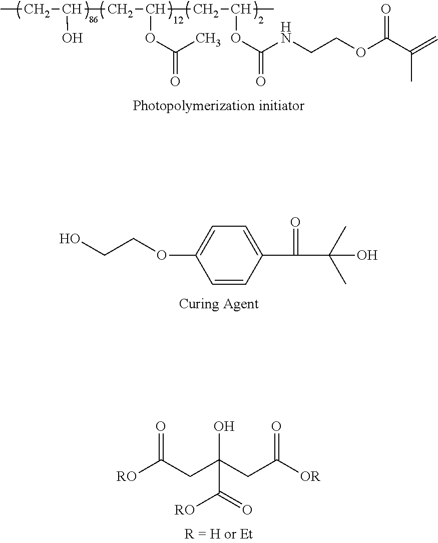

### Formation of Optically Anisotropic Layer

The alignment film manufactured above was continuously subjected to a rubbing treatment. At this time, the longitudinal direction of the long film was parallel to the transport direction, and the angle between the film longitudinal direction (transport direction) and the rotation axis of the rubbing roller was set to 78°. In a case where the film longitudinal direction (transport direction) is set to 90° and the clockwise direction is represented by a positive value with respect to the film width direction as a reference (0°) as observed from the film side, the rotation axis of the rubbing roller is 12°. That is, the position of the rotation axis of the rubbing roller is a position rotated by 78° counterclockwise with respect to the film longitudinal direction as a reference.

Using the rubbing-treated cellulose acylate film with an alignment film as a substrate, a composition (1) for forming an optically anisotropic layer containing a rod-like liquid crystal compound having the following composition was applied using a Geyser coating machine to form a composition layer. Furthermore, the absolute value of the weighted average helical twisting power of the chiral agent in the composition layer was 0.0 μm⁻¹.

Next, the obtained composition layer was heated at 95° C. for 60 seconds. This heating resulted in the alignment of the rod-like liquid crystal compound of the composition layer in a predetermined direction.

Thereafter, the composition layer was irradiated with ultraviolet rays (irradiation amount: 25 mJ/cm²) using an LED lamp (manufactured by AcroEdge Corporation) at 365 nm under a temperature condition of 30° C. in the air containing oxygen (oxygen concentration: approximately 20% by volume).

Subsequently, the obtained composition layer was heated at 95° C. for 10 seconds.

This was followed by nitrogen purging, and then the composition layer was irradiated (irradiation amount: 500 mJ/cm²) with ultraviolet rays using a metal halide lamp (manufactured by Eye Graphics Co., Ltd.) at 80° C. with an oxygen concentration of 100 ppm by volume to form an optically anisotropic layer in which the alignment state of the liquid crystal compound was fixed. An optical film (F-1) was prepared in this manner.

Composition (1) for forming optically anisotropic layer

| | |
|---|---|
| The following rod-like liquid crystal compound (A) | 80 parts by mass |
| The following rod-like liquid crystal compound (B) | 17 parts by mass |
| The following polymerizable compound (C) | 3 parts by mass |
| Ethylene oxide-modified trimethylolpropane triacrylate | 4 parts by mass |
| (V # 360, manufactured by Osaka Organic | |
| Chemical Industry Ltd.) | |
| Photopolymerization initiator (Irgacure 819, | 3 parts by mass |
| manufactured by BASF SE) | |
| The following left twisting chiral agent (L2) | 0.47 parts by mass |
| The following right twisting chiral agent (R2) | 0.42 parts by mass |
| The following polymer (A) | 0.08 parts by mass |
| Methyl isobutyl ketone | 78 parts by mass |
| Ethyl propionate | 78 parts by mass |

Rod-like liquid crystal compound (A) [mixture of the following liquid crystal compounds (RA), (RB), and (RC) at 84:14:2 (mass ratio)]

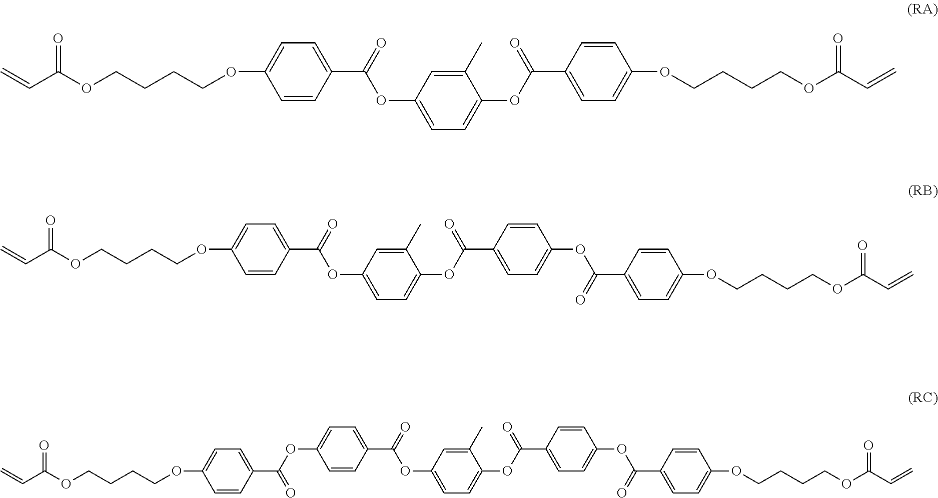

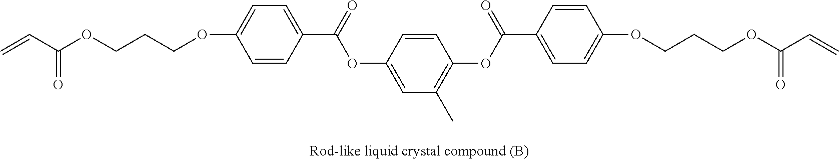 [SMILES: C=CC(=O)OCCCOc1ccc(C(=O)Oc2ccc(OC(=O)c3ccc(OCCCOC(=O)C=C)cc3)c(C)c2)cc1]

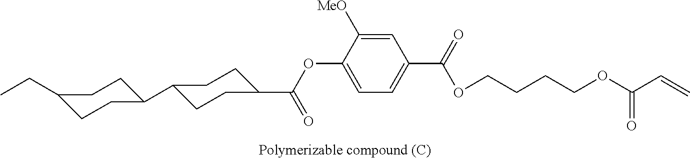 [SMILES: C=CC(=O)OCCCCOC(=O)c1ccc(OC(=O)C2CCC(C3CCC(CC)CC3)CC2)c(OC)c1]

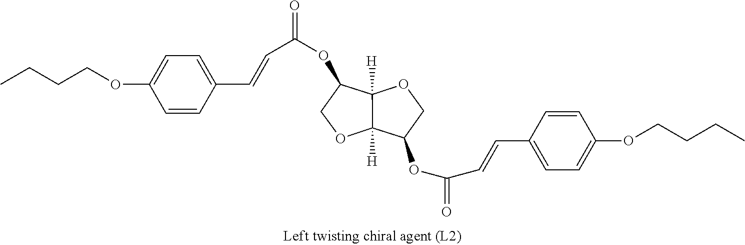 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

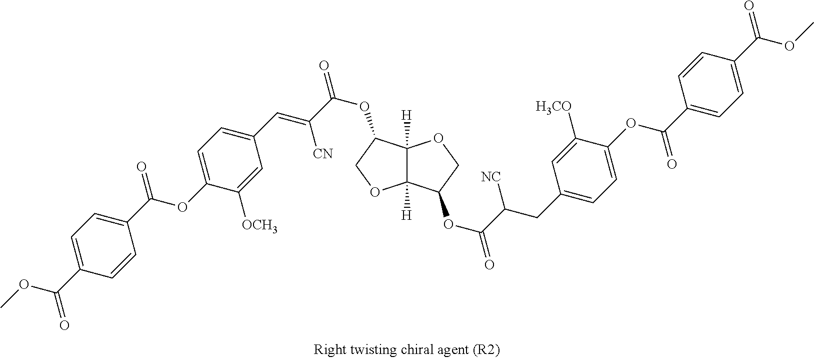

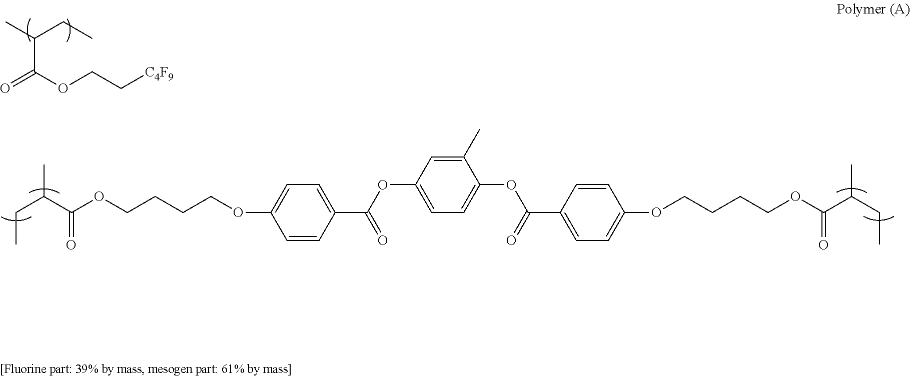

The optical film (F-1) prepared above was cut in parallel with the rubbing direction, and the optically anisotropic layer was observed from the cross-sectional direction with a polarization microscope. The thickness of the optically anisotropic layer was 2.7 μm, a region (second region) where the thickness (d2) of the optically anisotropic layer on the side of the substrate was 1.3 μm was formed in a homogeneous alignment without a twisted angle, and a region (first region) where the thickness (d1) of the optically anisotropic layer on the air side (on the side opposite to the substrate) was 1.4 μm was formed such that the liquid crystal compound was twistedly aligned.

Furthermore, the optical properties of the optical film (F-1) were determined using Axoscan of Axometrics, Inc. and analysis software (Multi-Layer Analysis) of Axometrics, Inc. The product (Δn2d2) of Δn2 and the thickness d2 at a wavelength of 550 nm in the second region was 177 nm, the twisted angle of the liquid crystal compound was 0°, and the alignment axis angle of the liquid crystal compound with respect to the long longitudinal direction on the side in contact with the substrate was −11° and the alignment axis angle thereof on the side in contact with the first region was −11°.

The product (Δn1d1) of Δn1 and the thickness d1 at a wavelength of 550 nm in the first region was 180 nm, the twisted angle of the liquid crystal compound was 80°, and the alignment axis angle of the liquid crystal compound with respect to the long longitudinal direction on the side in contact with the second region was −11° the alignment axis angle thereof on the air side was −91°.

### Examples 2 to 15 and Comparative Examples 1 to 3

An optical film was manufactured by the same method as in Example 1, except that the type and the blending amount of the additive were changed as shown in Table 1 below.

### Example 16

An optical film was manufactured by the same method as in Example 2, except that the modified polyvinyl alcohol-1 was changed to a modified polyvinyl alcohol-2 shown below.

Next, the support and the alignment film of the manufactured optical film were peeled off to isolate the optically anisotropic layer.

Modified polyvinyl alcohol-2 [in the following formula, the numerical value described in each repeating unit represents a content (% by mole) of each repeating unit with respect to all repeating units]

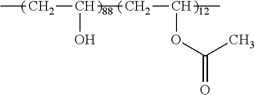

### Example 17

An optical film was manufactured by the same method as in Example 2, except that the modified polyvinyl alcohol-1 was changed to a modified polyvinyl alcohol-3 shown below.

Next, the pressure sensitive adhesive side of a pressure sensitive adhesive having a separator on one surface, and the optically anisotropic layer side of the manufactured optical film were bonded to each other, and the support and the alignment film were peeled off from the optical film to transfer the optically anisotropic layer to the pressure sensitive adhesive.

Modified polyvinyl alcohol-3 [in the following formula, the numerical value described in each repeating unit represents a content (% by mole) of each repeating unit with respect to all repeating units]

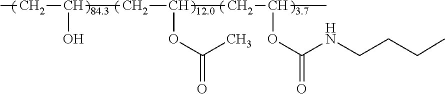

### Examples 18 and 19

An optical film was manufactured by the same method as in Example 2, except that the modified polyvinyl alcohol-1 was changed to that shown in Table 1 below. Furthermore, the details of the polymer used in Examples 18 and 19 are as follows.
Polyacrylic acid: AQUALIC (registered trade name) HL (manufactured by Nippon Shokubai Co., Ltd.)
Modified polyamide: AQ Nylon P70 (manufactured by Toray Industries, Inc.)

### Example 20

An optical film was manufactured by the same method as in Example 2, except that the composition (1) for forming an optically anisotropic layer was changed to a composition (2) for forming an optically anisotropic layer shown below and an optically anisotropic layer was formed under the following conditions.

Specifically, an alignment film was obtained by carrying out a rubbing treatment using a rotation axis of the rubbing roller as 17.5° in a case where the film longitudinal direction (transport direction) was defined as 90°, and the clockwise direction was represented by a positive value with reference to a width direction of the film as a reference (0°) in a case of being observed from the alignment film side. The composition (2) for forming an optically anisotropic layer was continuously applied onto the alignment film using a Geyser coating machine. A transportation speed of the film was set to 26 m/min. The coating film on the alignment film was heated with hot air at 130° C. for 90 seconds and then heated with hot air at 100° C. for 60 seconds to dry the solvent, and align and cure the discotic liquid crystal compound, and the coating film was irradiated with ultraviolet (UV) rays at 300 mJ/cm² at 80° C. to immobilize the alignment of the liquid crystal compound, thereby forming an optically anisotropic layer having a thickness of 2.0 μm. It was confirmed that the average tilt angle of the disc plane of the discotic liquid crystal compound with respect to the film surface was 90°, and the discotic liquid crystal compound was aligned perpendicular to the film surface.

In addition, in a case where the angle of the slow axis was parallel to the rotation axis of the rubbing roller and the film width direction of the film was set to 0° (the film longitudinal direction was set to 90° and the clockwise direction was indicated by a positive value with reference to the width direction of the film, as observed from the optically anisotropic layer side), the angle of the slow axis was −17.5°. The in-plane retardation of the optically anisotropic layer at a wavelength of 550 nm is 240 nm, and the optically anisotropic layer exhibits forward wavelength dispersibility.

Composition (2) for forming optically anisotropic layer

| | |
|---|---|
| The following discotic liquid crystal compound-1 | 80 parts by mass |
| The following discotic liquid crystal compound-2 | 20 parts by mass |
| The following alignment film interface alignment | 1.6 parts by mass |
| agent-1 | |
| The following fluorine-containing compound (F-1) | 0.21 parts by mass |
| The following fluorine-containing compound (F-2) | 0.075 parts by mass |
| The following fluorine-containing compound (F-3) | 0.1 parts by mass |
| Ethylene oxide-modified trimethylolpropane triacrylate | 5 parts by mass |
| Photopolymerization initiator (Irgacure 907, | 4 parts by mass |
| manufactured by BASF SE) | |
| Methyl ethyl ketone | 200 parts by mass |

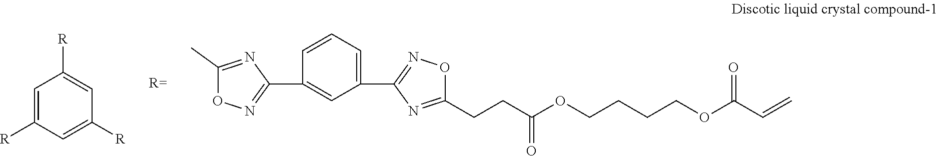

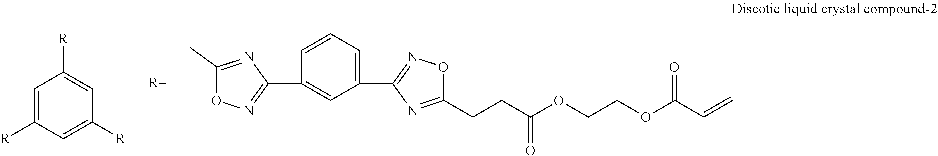

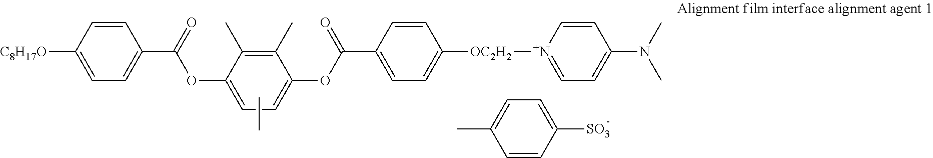

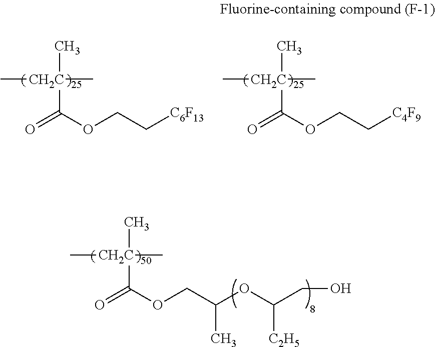

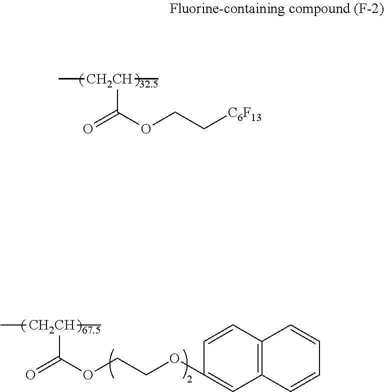

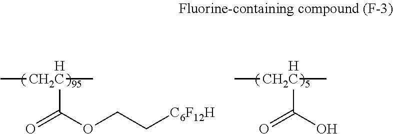

Furthermore, in the fluorine-containing compounds (F-1) to (F-3), numerical values (for example, “25”, “25”, and “50” in the fluorine-containing compound (F-1)) described laterally to the respective repeating units represent contents (% by mole) of the respective repeating units with respect to all the repeating units.

### Example 21

An optical film was manufactured by the same method as in Example 2, except that the composition (1) for forming an optically anisotropic layer was changed to a composition (3) for forming an optically anisotropic layer shown below and the thickness of an optically anisotropic layer thus formed was changed to 2.6 μm.

Composition (3) for forming optically anisotropic layer

| | |
|---|---|
| The rod-like liquid crystal compound (A) | 80 parts by mass |
| The rod-like liquid crystal compound (B) | 17 parts by mass |
| The polymerizable compound (C) | 3 parts by mass |
| Ethylene oxide-modified trimethylolpropane triacrylate | 4 parts by mass |
| (V # 360, manufactured by Osaka Organic Chemical | |
| Industry Ltd.) | |
| Photopolymerization initiator (Irgacure 819, | 3 parts by mass |
| manufactured by BASF SE) | |
| The left twisting chiral agent (L2) | 0.46 parts by mass |
| The right twisting chiral agent (R2) | 0.41 parts by mass |
| The polymer (A) | 0.08 parts by mass |
| The following polymer (B) | 0.38 parts by mass |
| Methyl isobutyl ketone | 117 parts by mass |
| Ethyl propionate | 23 parts by mass |
| Cyclohexane | 16 parts by mass |

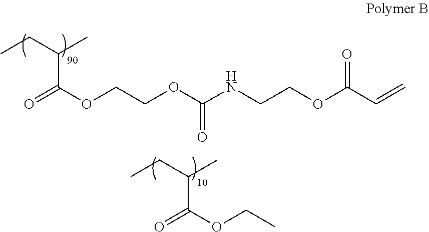

### Example 22

An optical film was manufactured by the same method as in Example 20, except that the composition (1) for forming an optically anisotropic layer was changed to a composition (4) for forming an optically anisotropic layer shown below and the position of the rotation axis of the rubbing roller was changed from −17.5° to +12.5°.

The thickness of the obtained optically anisotropic layer was 1.0 μm. It was confirmed that the average tilt angle of the major axis of the rod-like liquid crystal compound with respect to the film surface was 0° and the liquid crystal compound was horizontally aligned with respect to the film surface. In addition, in a case where the angle of the slow axis was orthogonal to the rotation axis of the rubbing roller and the film width direction of the film was set to 0° (the film longitudinal direction was set to 90° and the clockwise direction was indicated by a positive value with reference to the width direction of the film, as observed from the optically anisotropic layer C side), the angle of the slow axis was −77.5°. The in-plane retardation of the optically anisotropic layer at a wavelength of 550 nm is 116 nm, and the optically anisotropic layer exhibits forward wavelength dispersibility.

Composition (4) for forming optically anisotropic layer

| | |
|---|---|
| The rod-like liquid crystal compound (A) | 100 parts by mass |
| The photopolymerization initiator (Irgacure 907, | 6 parts by mass |
| manufactured by BASF SE) | |
| The fluorine-containing compound (F-1) | 0.25 parts by mass |
| The fluorine-containing compound (F-2) | 0.1 parts by mass |
| The ethylene oxide-modified trimethylolpropane | 4 parts by mass |
| triacrylate | |
| Methyl ethyl ketone | 337 parts by mass |

### Examples 23 and 24

An optical film was manufactured by the same method as in Example 1, except that the type and the blending amount of the additive were changed as shown in Table 2 below.

### Examples 25 to 30 and Comparative Example 4

An optical film was manufactured by the same method as in Example 1, except that the type and the blending amount of the additive were changed as shown in Table 2 below. Furthermore, the methods for synthesizing the copolymers A and B, the polymer C, and the copolymers D and E, which are used as the additives in Examples 25 to 30 and Comparative Example 4, and the structures thereof are as follows.

### Method for Synthesizing Copolymer A

17.5 g of ethanol (manufactured by FUJIFILM Wako Pure Chemical Corporation) was put into a 200 mL three-neck flask equipped with a stirrer, a cooling tube, a nitrogen introduction tube, and a thermometer, and heated to 70° C.

Next, a mixed solution of 21.0 g of NK ESTER M-230G (manufactured by Shin-Nakamura Chemical Co., Ltd.), 9.0 g of BLEMMER PSE-1300 (manufactured by NOF Corporation), 1.4 g of 2,2′-azobis(isobutyronitrile) (manufactured by FUJIFILM Wako Pure Chemical Corporation), and 50.4 g of ethanol was added dropwise thereto over 3 hours under a nitrogen flow.

After the dropwise addition, a solution obtained by dissolving 0.1 g of 2,2′-azobisisobutyronitrile in 5.7 g of ethanol was added to the reaction solution. Thereafter, the coating film was aged at 70° C. for 3 hours. The inside temperature was set to 78° C. and the mixture was further aged for 8 hours to obtain a copolymer A represented by the following formula. The obtained copolymer A had a weight-average molecular weight of 12,600 and a molecular weight distribution of 3.3.

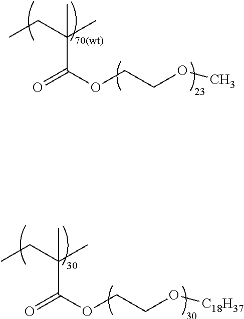

### Method for Synthesizing Copolymer B

A copolymer B represented by the following formula was obtained by the same method as for the copolymer A, except that NK ESTER M-230G used in the synthesis of the copolymer A was changed to methacrylic acid (manufactured by FUJIFILM Wako Pure Chemical Corporation). The copolymer B had a weight-average molecular weight of 10,800 and a molecular weight distribution of 3.1. The mixture was neutralized with sodium hydroxide (manufactured by FUJIFILM Wako Pure Chemical Corporation) to obtain a copolymer B.

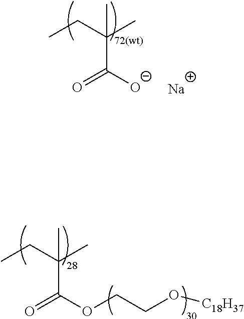

### Method for Synthesizing Polymer C

A polymer C represented by the following formula was obtained by the same method as for the copolymer A, except that the BLEMMER PSE-1300 used in the synthesis of the copolymer A was not used. The polymer C had a weight-average molecular weight of 14,800 and a molecular weight distribution of 2.3.

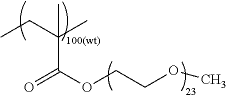

### Method for Synthesizing Copolymer D

A copolymer D represented by the following formula was obtained by the same method as for the copolymer A, except that BLEMMER PSE-1300 used in the synthesis of the copolymer A was changed to stearyl methacrylate (manufactured by FUJIFILM Wako Pure Chemical Corporation). The copolymer D had a weight-average molecular weight of 14,200 and a molecular weight distribution of 2.5.

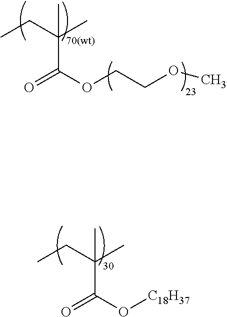

### Method for Synthesizing Copolymer E

A copolymer E represented by the following formula was obtained by the same method as for the copolymer B, except that the neutralization was not included in the synthesis of the copolymer B. The copolymer E had a weight-average molecular weight of 10,800 and a molecular weight distribution of 3.1.

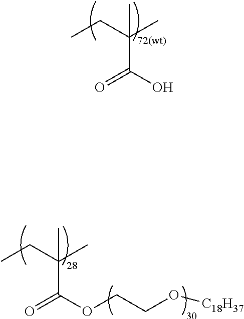

### Example 31

An optical film was manufactured by the same method as in Example 26, except that the composition (1) for forming an optically anisotropic layer was changed to a composition (5) for forming an optically anisotropic layer.

Composition (5) for forming optically anisotropic layer

| | |
|---|---|
| The rod-like liquid crystal compound (A) | 80 parts by mass |
| The rod-like liquid crystal compound (B) | 17 parts by mass |
| The polymerizable compound (C) | 3 parts by mass |
| Ethylene oxide-modified trimethylolpropane triacrylate | 4 parts by mass |
| (V # 360, manufactured by Osaka Organic | |
| Chemical Industry Ltd.) | |
| Photopolymerization initiator (Irgacure 819, | 3 parts by mass |
| manufactured by BASF SE) | |
| The left twisting chiral agent (L2) | 0.47 parts by mass |
| The right-twisted chiral agent (R2) | 0.42 parts by mass |
| The polymer (A) | 0.08 parts by mass |
| Lithium bis(trifluoromethanesulfonyl)imide | 0.10 parts by mass |
| (manufactured by FUJIFILM Wako Pure | |
| Chemical Corporation) | |
| Methyl isobutyl ketone | 78 parts by mass |
| Ethyl propionate | 78 parts by mass |

### Example 32

An optical film was manufactured by the same method as in Example 26, except that the composition for forming an alignment film was changed as follows.

Composition for forming alignment film

| | |
|---|---|
| Specific polymer: The modified polyvinyl alcohol-1 | 100 parts by mass |
| Specific additive: The copolymer A | 2.0 parts by mass |
| The photopolymerization initiator | 7.5 parts by mass |
| The curing agent | 1.75 parts by mass |
| Lithium bis(trifluoromethanesulfonyl)imide | 1.00 part by mass |
| (manufactured by FUJIFILM Wako Pure | |
| Chemical Corporation) | |
| Water | 2,620 parts by mass |
| Methanol | 873 parts by mass |

### Evaluations

The manufactured optical film or optically anisotropic layer, and the alignment film in the manufacturing process were evaluated as follows. The results are shown in Tables 1 and 2 below.

### Turbidity

The composition for forming an alignment film was allowed to transmit light and was visually observed according to the following standard.
A: The coating liquid was transparent.
B: The coating liquid was turbid.

### Dynamic Friction Coefficient

A load applied in a case where an SUS ball was rolled on the alignment film surface under a load of 100 g was measured, and a dynamic friction coefficient was measured.

### Alignment Properties

In a crossed-nicols state with a polarization microscope, the optically anisotropic layer in the obtained optical film was randomly observed at a magnification of 50 times in 10 visual fields (visual field size: 1,715×1,280 μm), and the visual fields were classified into the following three groups.
I: No optical defects are observed.
II: Some optical defects were observed, but it is at a level where there is no problem in practical use.
III: Many optical defects are observed and it is a level where there is a problem in practical use.

The 10 visual fields were evaluated in the following five stages.
A: All of the 10 visual fields are I or II, and the number of visual fields of II is 0 to 2.
B: All of the 10 visual fields are I or II, and the number of visual fields of II is 3 to 5.
C: All of the 10 visual fields are I or II, and the number of visual fields of II is 6 to 10.
D: The 10 visual fields include III, and the number of visual fields of III is 1 to 5.
E: The 10 visual fields include III, and the number of visual fields of III is 6 to 10.

### Bright Point Defects

Two polarizing plates were overlapped on a Schaukasten in a crossed-nicols state, and the obtained optical film (observation area: 1×1 m) was interposed between the two polarizing plates to allow light to pass through the Schaukasten. Furthermore, in Examples 16 and 17, the pressure sensitive adhesive side of the optically anisotropic layer with a pressure sensitive adhesive from which the separator had been peeled off was bonded to the polarizing plate, and another polarizing plate was disposed in a crossed-nicols state, thereby creating a similar state. The optical film was observed from the polarizing plate using a loupe, and defects having a diameter of 100 μm or more were marked. A cross-section was obtained by cutting with a microtome to pass through the center of the marked defect, and observation of the cross-section with an optical microscope in a cross-sectional direction was carried out. The defects in which foreign substances were observed in the optically anisotropic layer were counted and evaluated according to the following standard.
A: The number of defects was 2 or less.
B: The number of defects was 3 or 4.
C: The number of defects was 5 to 8.
D: The number of defects was 8 to 20.
E: The number of defects is 21 or more.

### Component Analysis of Bright Point Defects

With regard to Examples 16 and 17, 10 of the bright point defects were collected, the central part of the bright point was subjected to analysis of the components in the depth direction with a time-of-flight secondary ion mass spectrometer (TOF-SIMS) (“SIMS5” manufactured by IONTOF Co., Ltd.) while etching the film in the depth direction of the optically anisotropic layer using an Ar+ cluster gun, and the presence or absence of the additive having an alkyl group and the polymer having no alkyl group was confirmed from the generated fragment ions. In a case where the components were detected with four or more defects, it was determined that the components were detected.

TABLE 1

| | | Composition for forming alignment film | | | | | | Optical film | | |
|---|---|---|---|---|---|---|---|---|---|---|
| | | | Additive | | | Alignment | Composition | Thickness | | |
| | | | | Addition | | film | for forming | of optically | | |
| | | | | amount | | Dynamic | optically | anisotropic | | Bright |
| | Subject to be | | | (parts by | | friction | anisotropic | layer | Alignment | point |
| | manufactured | Polymer | Type | mass) | Turbidity | coefficient | layer | (μm) | properties | defects |
| Example 1 | Optical film | Modified | Sodium | 1.5 | A | 0.48 | (1) | 2.7 | A | C |
| | F-1 | polyvinyl | dodecyl sulfate | | | | | | | |
| | | alcohol-1 | | | | | | | | |
| Example 2 | Optical film | Modified | Sodium | 1.6 | A | 0.30 | (1) | 2.7 | A | B |
| | F-2 | polyvinyl | dodecyl sulfate | | | | | | | |
| | | alcohol-1 | | | | | | | | |
| Example 3 | Optical film | Modified | Sodium | 1.7 | A | 0.25 | (1) | 2.7 | B | A |
| | F-3 | polyvinyl | dodecyl sulfate | | | | | | | |
| | | alcohol-1 | | | | | | | | |
| Example 4 | Optical film | Modified | Sodium | 2.0 | A | 0.14 | (1) | 2.7 | C | A |
| | F-4 | polyvinyl | dodecyl sulfate | | | | | | | |
| | | alcohol-1 | | | | | | | | |
| Example 5 | Optical film | Modified | Polyoxyethylene | 0.05 | A | 0.48 | (1) | 2.7 | A | C |
| | F-5 | polyvinyl | (10) cetyl ether | | | | | | | |
| | | alcohol-1 | | | | | | | | |
| Example 6 | Optical film | Modified | Polyoxyethylene | 0.2 | A | 0.41 | (1) | 2.7 | B | C |
| | F-6 | polyvinyl | (10) cetyl ether | | | | | | | |
| | | alcohol-1 | | | | | | | | |
| Example 7 | Optical film | Modified | Polyoxyethylene | 0.3 | A | 0.27 | (1) | 2.7 | C | B |
| | F-7 | polyvinyl | (10) cetyl ether | | | | | | | |
| | | alcohol-1 | | | | | | | | |
| Example 8 | Optical film | Modified | Polyoxyethylene | 0.5 | A | 0.20 | (1) | 2.7 | C | A |
| | F-8 | polyvinyl | (10) cetyl ether | | | | | | | |
| | | alcohol-1 | | | | | | | | |
| Example 9 | Optical film | Modified | Tetraamyl- | 1.0 | A | 0.49 | (1) | 2.7 | B | C |
| | F-9 | polyvinyl | ammonium | | | | | | | |
| | | alcohol-1 | bromide | | | | | | | |
| Example 10 | Optical film | Modified | Tetrahexyl- | 1.0 | A | 0.46 | (1) | 2.7 | B | C |
| | F-10 | polyvinyl | ammonium | | | | | | | |
| | | alcohol-1 | bromide | | | | | | | |
| Example 11 | Optical film | Modified | Tetra-n-octyl- | 1.0 | A | 0.44 | (1) | 2.7 | B | C |
| | F-11 | polyvinyl | ammonium | | | | | | | |
| | | alcohol-1 | bromide | | | | | | | |
| Example 12 | Optical film | Modified | Trimethyl- | 1.0 | A | 0.28 | (1) | 2.7 | C | B |
| | F-12 | polyvinyl | stearylammonium | | | | | | | |
| | | alcohol-1 | bromide | | | | | | | |
| Example 13 | Optical film | Modified | Polyoxyethylene | 0.2 | A | 0.38 | (1) | 2.7 | A | B |
| | F-13 | polyvinyl | (20) docosyl ether | | | | | | | |
| | | alcohol-1 | | | | | | | | |
| Example 14 | Optical film | Modified | Melissic acid | 1.0 | B | 0.46 | (1) | 2.7 | C | C |
| | F-14 | polyvinyl | | | | | | | | |
| | | alcohol-1 | | | | | | | | |
| Example 15 | Optical film | Modified | Hexadecyl- | 1.0 | B | 0.49 | (1) | 2.7 | C | C |
| | F-15 | polyvinyl | benzene | | | | | | | |
| | | alcohol-1 | | | | | | | | |
| Example 16 | Optical film | Modified | Sodium | 1.5 | A | 0.29 | (1) | 2.7 | A | B |
| | F-16 | polyvinyl | dodecyl sulfate | | | | | | | |
| | | alcohol-2 | | | | | | | | |
| Example 17 | Optical film | Modified | Sodium | 1.5 | A | 0.32 | (1) | 2.7 | A | B |
| | F-17 | polyvinyl | dodecyl sulfate | | | | | | | |
| | | alcohol-3 | | | | | | | | |
| Example 18 | Optical film | Polyacrylic | Sodium | 1.5 | A | 0.30 | (1) | 2.7 | C | B |
| | F-18 | acid | dodecyl sulfate | | | | | | | |
| Example 19 | Optical film | Modified | Sodium | 1.5 | A | 0.32 | (1) | 2.7 | C | B |
| | F-19 | polyamide | dodecyl sulfate | | | | | | | |

TABLE 2

| | | Composition for forming | | | | | | | | |
|---|---|---|---|---|---|---|---|---|---|---|
| | | alignment film | | | | | | Optical film | | |
| | | | Additive | | | Alignment | Composition | Thickness | | |
| | | | | Addition | | film | for forming | of optically | | |
| | Subject | | | amount | | Dynamic | optically | anistropic | | Bright |
| | to be | | | (parts by | | friction | anisotropic | layer | Alignment | point |
| | manufactured | Polymer | Type | mass) | Turbidity | coefficient | layer | (μm) | properties | defects |
| Example 20 | Optical film | Modified | Sodium | 1.5 | A | 0.30 | (2) | 2.0 | A | B |
| | F-20 | Polyvinyl | dodecyl | | | | | | | |
| | | alcohol-1 | sulfate | | | | | | | |
| Example 21 | Optical film | Modified | Sodium | 1.5 | A | 0.30 | (3) | 2.6 | B | B |
| | F-21 | Polyvinyl | dodecyl | | | | | | | |
| | | alcohol-1 | sulfate | | | | | | | |
| Example 22 | Optical film | Modified | Sodium | 1.2 | A | 0.30 | (4) | 1.0 | A | B |
| | F-22 | Polyvinyl | dodecyl | | | | | | | |
| | | alcohol-1 | sulfate | | | | | | | |
| Example 23 | Optical film | Modified | Sodium | 2.5 | A | 0.38 | (1) | 2.7 | B | B |
| | F-23 | Polyvinyl | 4′-decyloxy- | | | | | | | |
| | | alcohol-1 | biphenyl-4- | | | | | | | |
| | | | carboxylate | | | | | | | |
| Example 24 | Optical film | Modified | 4′-Decyloxy- | 2.5 | B | 0.49 | (1) | 2.7 | B | C |
| | F-24 | Polyvinyl | biphenyl-4- | | | | | | | |
| | | alcohol-1 | carboxylic | | | | | | | |
| | | | acid | | | | | | | |
| Example 25 | Optical film | Modified | Copolymer A | 1.5 | A | 0.36 | (1) | 2.7 | A | B |
| | F-25 | Polyvinyl | | | | | | | | |
| | | alcohol-1 | | | | | | | | |
| Example 26 | Optical film | Modified | Copolymer A | 2.0 | A | 0.26 | (1) | 2.7 | A | A |
| | F-26 | Polyvinyl | | | | | | | | |
| | | alcohol-1 | | | | | | | | |
| Example 27 | Optical film | Modified | Copolymer A | 3.0 | A | 0.21 | (1) | 2.7 | A | A |
| | F-27 | Polyvinyl | | | | | | | | |
| | | alcohol-1 | | | | | | | | |
| Example 28 | Optical film | Modified | Copolymer B | 3.0 | A | 0.35 | (1) | 2.7 | A | B |
| | F-28 | Polyvinyl | | | | | | | | |
| | | alcohol-1 | | | | | | | | |
| Example 29 | Optical film | Modified | Copolymer D | 3.0 | A | 0.37 | (1) | 2.7 | A | B |
| | F-29 | Polyvinyl | | | | | | | | |
| | | alcohol-1 | | | | | | | | |
| Example 30 | Optical film | Modified | Copolymer E | 3.0 | B | 0.48 | (1) | 2.7 | A | C |
| | F-30 | Polyvinyl | | | | | | | | |
| | | alcohol-1 | | | | | | | | |
| Comparative | Optical film | Modified | None | 0.0 | A | 0.52 | (1) | 2.7 | A | E |
| Example 1 | F-31 | Polyvinyl | | | | | | | | |
| | | alcohol-1 | | | | | | | | |
| Comparative | Optical film | Modified | Sodium ethyl | 2.0 | A | 0.55 | (1) | 2.7 | B | E |
| Example 2 | F-32 | Polyvinyl | sulfate | | | | | | | |
| | | alcohol-1 | | | | | | | | |
| Comparative | Optical film | Modified | Tetrabutyl- | 2.0 | A | 0.54 | (1) | 2.7 | B | E |
| Example 3 | F-33 | Polyvinyl | ammonium | | | | | | | |
| | | alcohol-1 | bromide | | | | | | | |
| Comparative | Optical film | Modified | Copolymer C | 2.0 | A | 0.50 | (1) | 2.7 | B | D |
| Example 4 | F-34 | Polyvinyl | | | | | | | | |
| | | alcohol-1 | | | | | | | | |

From the results shown in Tables 1 and 2, it was found that in a case where the specific additive is not blended in the composition for forming an alignment film or in a case where the additive not corresponding to the specific additive is blended, the aligning properties of the liquid crystal compound in the optically anisotropic layer are good, but the occurrence of bright point defects cannot be suppressed (Comparative Examples 1 to 4).

On the other hand, it was found that in a case where an alignment film is formed of the composition for forming an alignment film, containing the specific additive and the specific polymer, the aligning properties of the liquid crystal compound in the optically anisotropic layer are improved and the occurrence of bright point defects can be suppressed (Examples 1 to 30).

In particular, from the comparison between Example 1 and Example 14, it was found that in a case where the number of carbon atoms of the alkyl group included in the specific additive is 12 to 22, the aligning properties of the liquid crystal compound in the optically anisotropic layer are further improved.

Furthermore, from the comparison between Example 1 and Example 15, it was found that in a case where the specific additive had a hydrophilic group, the aligning properties of the liquid crystal compound in the optically anisotropic layer are further improved.

In addition, from the comparison of Examples 2, 18, and 19, it was found that in a case where the specific polymer is a polyvinyl alcohol or a modified polyvinyl alcohol, the aligning properties of the liquid crystal compound in the optically anisotropic layer are further improved, and the occurrence of bright point defects in the optical film can be further suppressed.

Moreover, from the comparison between Example 1 and Example 25, or the comparison between Example 4 and Example 26, it was found that in a case where the specific additive is a high-molecular-weight compound, the occurrence of bright point defects can be further suppressed while maintaining excellent aligning properties.

Furthermore, from the comparison between Examples 23 and 24, it was found that in a case where any hydrophilic group contained in the specific additive is a neutralized product such as an ionic carboxylate, the occurrence of bright point defects can be further suppressed.

In addition, although not shown in Table 2, it was found that in Examples 31 and 32, the aligning properties of the liquid crystal compound in the optically anisotropic layer are improved and the occurrence of bright point defects can be suppressed.

What is claimed is:

1. An optical film comprising:
an alignment film; and
an optically anisotropic layer,
wherein the optically anisotropic layer is a layer formed of a composition for forming an optically anisotropic layer, containing a polymerizable liquid crystal compound, and
the alignment film is a film formed of a composition for forming an alignment film, containing an additive having an alkyl group having 5 to 29 carbon atoms and a polymer having no alkyl group having 5 to 29 carbon atoms.

2. The optical film according to claim 1,
wherein the additive has a hydrophilic group.

3. The optical film according to claim 1,
wherein the additive has an alkyl group having 12 to 22 carbon atoms.

4. The optical film according to claim 1,
wherein the polymer is a polyvinyl alcohol or a modified polyvinyl alcohol.

5. An optically anisotropic layer formed of a composition for forming an optically anisotropic layer, containing a polymerizable liquid crystal compound,
wherein bright point defects having a size of 100 μm or more are present at 1 to 80 pieces/10 m² in the optically anisotropic layer, and
a core of the bright point defect contains an additive having an alkyl group having 5 to 29 carbon atoms and a polymer having no alkyl group having 5 to 29 carbon atoms.

6. The optically anisotropic layer according to claim 5,
wherein the additive has a hydrophilic group.

7. The optically anisotropic layer according to claim 5,
wherein the additive has an alkyl group having 12 to 22 carbon atoms.

8. The optically anisotropic layer according to claim 5,
wherein the polymer is a polyvinyl alcohol or a modified polyvinyl alcohol.

9. A composition for forming an alignment film, comprising:
an additive having an alkyl group having 5 to 29 carbon atoms; and
a polymer having no alkyl group having 5 to 29 carbon atoms.

10. The composition for forming an alignment film according to claim 9,
wherein the additive has a hydrophilic group.

11. The composition for forming an alignment film according to claim 9,
wherein the additive has an alkyl group having 12 to 22 carbon atoms.

12. The composition for forming an alignment film according to claim 9,
wherein the polymer is a polyvinyl alcohol or a modified polyvinyl alcohol.

13. A method for producing an optical film, comprising:
an alignment film forming step of forming an alignment film on a support, using the composition for forming an alignment film according to claim 9;
a rubbing step of subjecting the alignment film to a rubbing treatment; and
an optically anisotropic layer forming step of forming an optically anisotropic layer on the rubbing-treated alignment film, using a composition for forming an optically anisotropic layer, containing a polymerizable liquid crystal compound.

14. A polarizing plate comprising:
the optical film according to claim 1; and
a polarizer.

15. An image display device comprising:
the optical film according to claim 1.

16. The image display device according to claim 15,
wherein the image display device is a liquid crystal display device.

17. The image display device according to claim 15,
wherein the image display device is an organic EL display device.

18. A polarizing plate comprising:
the optically anisotropic layer according to claim 5; and
a polarizer.

19. An image display device comprising:
the optically anisotropic layer according to claim 5.
